(19) United States
(12) Patent Application Publication
(10) Pub. No.: US 2025/0374126 A1
(43) Pub. Date: Dec. 4, 2025

(54) TECHNIQUES FOR SENSING AND COMMUNICATION BEAM CONFLICT IN SIDELINK

(71) Applicant: QUALCOMM Incorporated, San Diego, CA (US)

(72) Inventors: Stelios STEFANATOS, San Diego, CA (US); Junyi LI, Greentown, PA (US); Kapil GULATI, Belle Mead, NJ (US); Preeti KUMARI, San Diego, CA (US); Shijun WU, San Diego, CA (US)

(21) Appl. No.: 19/154,318

(22) PCT Filed: Mar. 28, 2024
(86) PCT No.: PCT/US2024/021998

§ 371 Date: Aug. 6, 2025

(30) Foreign Application Priority Data
Apr. 5, 2023 (GR) 20230100290

(51) Int. Cl. H04W 28/26; H04W 16/28; H04W 72/02; H04W 72/40; H04W 76/20; H04W 92/18

(52) U.S. Cl. CPC H04W 28/26; H04W 16/28; H04W 72/02; H04W 72/40; H04W 76/20; H04W 92/18

(57) ABSTRACT

Methods, systems, and devices for wireless communications are described. For example, a user equipment (UE) in sidelink communication may coordinate directly with other UEs to reduce or prevent scenarios in which the UE is performing sensing and communication operations at the same time even in cases where different beam parameters are used for sensing and communication. For example, a sensing UE may be configured to perform sensing operations and ignore communication signals when performing the sensing operations. In such cases, other UEs may be aware that the sensing UE may not attempt to decode communications signals. Thus, the other UEs may refrain from transmitting communications signals to the sensing UE (e.g., when the sensing UE is performing a sensing operation) during the reserved sidelink resources.

### CROSS REFERENCE

The present Application for Patent is a 371 national phase filing of International Patent Application No. PCT/US2024/021998 by STEFANATOS et al., entitled “TECHNIQUES FOR SENSING AND COMMUNICATION BEAM CONFLICT IN SIDELINK,” filed Mar. 28, 2024, which claims priority to Greek Patent Application No. 20230100290 by STEFANATOS et al., entitled “TECHNIQUES FOR SENSING AND COMMUNICATION BEAM CONFLICT IN SIDELINK,” filed Apr. 5, 2023, each of which is assigned to the assignee hereof, and each of which is expressly incorporated by reference in its entirety herein.

### FIELD OF TECHNOLOGY

The following relates to wireless communications, including techniques for sensing and communication beam conflict in sidelink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some cases, a sensing user equipment (UE) may be configured to perform sensing operations and ignore a communications signal (e.g., a sidelink message) when performing transmission or reception of sensing signals as part of a sensing operation (e.g., due to being able to support operations using a single beam or beam direction). In such cases, other UEs may be aware that the sensing UE will not attempt to decode communications signals and the other UEs may refrain from transmitting communication signals (e.g., data messages or control messages) to the sensing UE (e.g., when the sensing UE is performing a sensing operation). For example, a first UE (e.g., transmitting UE) may transmit to a second UE (e.g., receiving UE) an indication of whether the first UE will attempt to decode communication signals during resources reserved for sensing purposes. Thus, the second UE may be aware if the first UE will attempt to decode during this period (e.g., the reserved resources) and may refrain from transmitting communication signals (e.g., if the first UE will refrain from decoding during the reserved resources).

A method for wireless communications at a first UE is described. The method may include transmitting a sidelink reservation message that indicates a set of sidelink resources reserved for a sensing operation for the first UE, transmitting a control message indicating whether the first UE will perform one or more decoding operations for one or more sidelink data messages during the set of sidelink resources reserved for the sensing operation, and performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

An apparatus for wireless communications at a first UE is described. The apparatus may include a processor, memory coupled with the processor, and instructions stored in the memory. The instructions may be executable by the processor to cause the apparatus to transmit a sidelink reservation message that indicates a set of sidelink resources reserved for a sensing operation for the first UE, transmit a control message indicating whether the first UE will perform one or more decoding operations for one or more sidelink data messages during the set of sidelink resources reserved for the sensing operation, and perform the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

Another apparatus for wireless communications at a first UE is described. The apparatus may include means for transmitting a sidelink reservation message that indicates a set of sidelink resources reserved for a sensing operation for the first UE, means for transmitting a control message indicating whether the first UE will perform one or more decoding operations for one or more sidelink data messages during the set of sidelink resources reserved for the sensing operation, and means for performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

A non-transitory computer-readable medium storing code for wireless communications at a first UE is described. The code may include instructions executable by a processor to transmit a sidelink reservation message that indicates a set of sidelink resources reserved for a sensing operation for the first UE, transmit a control message indicating whether the first UE will perform one or more decoding operations for one or more sidelink data messages during the set of sidelink resources reserved for the sensing operation, and perform the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

Some examples of the method, apparatuses, and non-transitory computer-readable medium described herein may further include operations, features, means, or instructions for receiving a second message that indicates a second set of sidelink resources scheduled for the one or more sidelink data messages for reception, by the first UE, using one or more first beam parameters corresponding to a first beam direction, where the second set of sidelink resources at least partially overlaps the set of sidelink resources reserved for the sensing operation, and where the sensing operation may be associated with one or more second beam parameters corresponding to a second beam direction.

In some examples of the method, apparatuses, and non-transitory computer-readable medium described herein, performing the sensing operation and the one or more decoding operations may include operations, features, means, or instructions for receiving the one or more sidelink data messages during the second set of sidelink resources based on receiving the second message and decoding the one or more sidelink data messages during the second set of sidelink resources.

In some examples of the method, apparatuses, and non-transitory computer-readable medium described herein, transmitting the control message may include operations, features, means, or instructions for transmitting the control message indicating that the first UE will perform sensing and will refrain from performing the one or more decoding operations during the set of sidelink resources based on the one or more first beam parameters being different from the one or more second beam parameters.

In some examples of the method, apparatuses, and non-transitory computer-readable medium described herein, the set of sidelink resources reserved for the sensing operation includes multiple consecutive slots.

In some examples of the method, apparatuses, and non-transitory computer-readable medium described herein, transmitting the control message may include operations, features, means, or instructions for transmitting an indication that the first UE will perform one or more decoding operations for one or more sidelink data messages for all slots of the multiple consecutive slots.

In some examples of the method, apparatuses, and non-transitory computer-readable medium described herein, transmitting the control message may include operations, features, means, or instructions for transmitting an indication of whether the first UE will perform the one or more decoding operations for the one or more sidelink data messages for each slot of the multiple consecutive slots.

In some examples of the method, apparatuses, and non-transitory computer-readable medium described herein, performing the sensing operation and the one or more decoding operations may include operations, features, means, or instructions for applying a reception beamforming gain for reception of the one or more sidelink data messages during the set of sidelink resources reserved for the sensing operation.

Some examples of the method, apparatuses, and non-transitory computer-readable medium described herein may further include operations, features, means, or instructions for transmitting an indication of the reception beamforming gain applied to the one or more sidelink data messages.

In some examples of the method, apparatuses, and non-transitory computer-readable medium described herein, transmitting the indication of the reception beamforming gain may include operations, features, means, or instructions for transmitting a gain offset that may be indicative of the reception beamforming gain applied to the one or more sidelink data messages.

In some examples of the method, apparatuses, and non-transitory computer-readable medium described herein, transmitting the indication of the reception beamforming gain may include operations, features, means, or instructions for transmitting the indication of the reception beamforming gain via the sidelink reservation message or via a PC5-RRC connection.

In some examples of the method, apparatuses, and non-transitory computer-readable medium described herein, transmitting the indication of the reception beamforming gain may include operations, features, means, or instructions for transmitting an indication of one or more beam parameters corresponding to a beam direction that may be associated with the one or more decoding operations.

In some examples of the method, apparatuses, and non-transitory computer-readable medium described herein, transmitting the indication of the one or more beam parameters may include operations, features, means, or instructions for transmitting an indication of an angle interval as part of the indication of the one or more beam parameters.

In some examples of the method, apparatuses, and non-transitory computer-readable medium described herein, transmitting the indication of the one or more beam parameters may include operations, features, means, or instructions for transmitting an indication of a set of one or more transmission configuration indication states as part of the one or more beam parameters.

In some examples of the method, apparatuses, and non-transitory computer-readable medium described herein, transmitting the control message may include operations, features, means, or instructions for transmitting the control message via a sidelink control information message or via a medium access control (MAC) control element (MAC-CE).

A method for wireless communications at a first UE is described. The method may include receiving a sidelink reservation message that indicates a set of sidelink resources reserved for a sensing operation at a second UE, receiving a control message indicating whether the second UE will perform one or more decoding operations for one or more sidelink data messages during the set of sidelink resources reserved for the sensing operation, and transmitting an indication of one or more sidelink resources selected for transmission of the one or more sidelink data messages, to the second UE, based on the control message.

An apparatus for wireless communications at a first UE is described. The apparatus may include a processor, memory coupled with the processor, and instructions stored in the memory. The instructions may be executable by the processor to cause the apparatus to receive a sidelink reservation message that indicates a set of sidelink resources reserved for a sensing operation at a second UE, receive a control message indicating whether the second UE will perform one or more decoding operations for one or more sidelink data messages during the set of sidelink resources reserved for the sensing operation, and transmit an indication of one or more sidelink resources selected for transmission of the one or more sidelink data messages, to the second UE, based on the control message.

Another apparatus for wireless communications at a first UE is described. The apparatus may include means for receiving a sidelink reservation message that indicates a set of sidelink resources reserved for a sensing operation at a second UE, means for receiving a control message indicating whether the second UE will perform one or more decoding operations for one or more sidelink data messages during the set of sidelink resources reserved for the sensing operation, and means for transmitting an indication of one or more sidelink resources selected for transmission of the one or more sidelink data messages, to the second UE, based on the control message.

A non-transitory computer-readable medium storing code for wireless communications at a first UE is described. The code may include instructions executable by a processor to receive a sidelink reservation message that indicates a set of sidelink resources reserved for a sensing operation at a second UE, receive a control message indicating whether the second UE will perform one or more decoding operations for one or more sidelink data messages during the set of sidelink resources reserved for the sensing operation, and transmit an indication of one or more sidelink resources selected for transmission of the one or more sidelink data messages, to the second UE, based on the control message.

In some examples of the method, apparatuses, and non-transitory computer-readable medium described herein, transmitting the indication of the one or more sidelink resources selected for the transmission of the one or more sidelink data messages may include operations, features, means, or instructions for transmitting, to the second UE, the indication of the one or more sidelink resources selected for the transmission of the one or more sidelink data messages, where the one or more sidelink resources may be selected based on exclusion of one or more sidelink resources of the set of sidelink resources reserved for the sensing operation at the second UE, where the one or more sidelink resources may be excluded from the set of sidelink resources based on the control message indicating that the first UE will perform sensing and will refrain from performing the one or more decoding operations during the set of sidelink resources.

Some examples of the method, apparatuses, and non-transitory computer-readable medium described herein may further include operations, features, means, or instructions for receiving, from the second UE, an indication of a reception beamforming gain for the one or more sidelink data messages, an indication of one or more beam parameters corresponding to a beam direction, the beam direction associated with the one or more decoding operations, or a combination thereof.

In some examples of the method, apparatuses, and non-transitory computer-readable medium described herein, receiving the indication of the one or more beam parameters may include operations, features, means, or instructions for receiving an indication of an angle interval as part of the indication of the one or more beam parameters.

In some examples of the method, apparatuses, and non-transitory computer-readable medium described herein, transmitting the indication of the one or more sidelink resources selected for the transmission of the one or more sidelink data messages may include operations, features, means, or instructions for transmitting, to the second UE, the indication of the one or more sidelink resources selected for the transmission of the one or more sidelink data messages, where the one or more sidelink resources may be selected based on exclusion of one or more sidelink resources of the set of sidelink resources reserved for the sensing operation at the second UE, where the one or more sidelink resources may be excluded from the set of sidelink resources based on the indication of the reception beamforming gain, the indication of the one or more beam parameters, or a combination thereof.

In some examples of the method, apparatuses, and non-transitory computer-readable medium described herein, the one or more sidelink resources may be excluded from the set of sidelink resources based on the reception beamforming gain exceeding a threshold.

Some examples of the method, apparatuses, and non-transitory computer-readable medium described herein may further include operations, features, means, or instructions for excluding one or more sidelink resources from a window used for selecting the one or more sidelink resources selected for the transmission of the one or more sidelink data messages and including the one or more sidelink resources in the one or more sidelink resources selected for the transmission of the one or more sidelink data messages based on a quantity of resources within the window being below a threshold.

In some examples of the method, apparatuses, and non-transitory computer-readable medium described herein, selecting the one or more excluded resources may include operations, features, means, or instructions for selecting the one or more excluded resources based on a reference signal received power associated with each of the one or more excluded resources, a priority value associated with each of the one or more excluded resources, or a combination thereof.

In some examples of the method, apparatuses, and non-transitory computer-readable medium described herein, the reference signal received power and the priority value may be based on one or more beamforming capabilities indicated by the sidelink reservation message and the one or more excluded resources may be associated with one or more sidelink resources of the set of sidelink resources reserved for the sensing operation at the second UE.

Some examples of the method, apparatuses, and non-transitory computer-readable medium described herein may further include operations, features, means, or instructions for transmitting the one or more sidelink data messages during the set of sidelink resources reserved for the sensing operation based on the control message indicating that the second UE will perform the one or more decoding operations during the set of sidelink resources.

Some examples of the method, apparatuses, and non-transitory computer-readable medium described herein may further include operations, features, means, or instructions for refraining from transmitting the one or more sidelink data messages during the set of sidelink resources reserved for the sensing operation based on the control message indicating that the second UE will perform sensing and will refrain from performing the one or more decoding operations during the set of sidelink resources.

### BRIEF DESCRIPTION OF THE DRAWINGS

FIG. 1 shows an example of a wireless communications system that supports techniques for sensing and communication beam conflict in sidelink in accordance with one or more aspects of the present disclosure.

FIG. 2 shows an example of a wireless communications system that supports techniques for sensing and communication beam conflict in sidelink in accordance with one or more aspects of the present disclosure.

FIGS. 3A and 3B show an example of a wireless communications system that supports techniques for sensing and communication beam conflict in sidelink in accordance with one or more aspects of the present disclosure.

FIG. 4 shows an example of a sidelink resource pool that supports techniques for sensing and communication beam conflict in sidelink in accordance with one or more aspects of the present disclosure.

FIG. 5 shows an example of a process flow that supports techniques for sensing and communication beam conflict in sidelink in accordance with one or more aspects of the present disclosure.

FIGS. 6 and 7 show block diagrams of devices that support techniques for sensing and communication beam conflict in sidelink in accordance with one or more aspects of the present disclosure.

FIG. 8 shows a block diagram of a communications manager that supports techniques for sensing and communication beam conflict in sidelink in accordance with one or more aspects of the present disclosure.

FIG. 9 shows a diagram of a system including a device that supports techniques for sensing and communication beam conflict in sidelink in accordance with one or more aspects of the present disclosure.

FIGS. 10 through 13 show flowcharts illustrating methods that support techniques for sensing and communication beam conflict in sidelink in accordance with one or more aspects of the present disclosure.

### DETAILED DESCRIPTION

A device, such as a user equipment (UE), may support joint communication and sensing (JCS). That is, the device may perform monostatic sensing (e.g., monitoring for a response to a transmitted probing signal that may be reflected by a target) and receive a communication signal at the same time or at least in partially overlapping time resources. In a full-duplex sensing operation, a receiver of the monostatic sensing node may operate (e.g., may monitor) at the same time as a transmitter of the monostatic sensing node operates (e.g., transmits). In order to identify angular positions of targets, a device may apply beamforming to both the sensing transmitter and receiver. In these cases, one option is to have the direction and beamwidth of the transmitter beam and receiver beam be the same (or have similar parameters). In such cases, a full-duplex device that supports JCS (e.g., full-duplex sensing and full duplex communication) may be employed.

In a dual reception operation where a device is capable of performing sensing and communication (e.g., communication of data), the sensing receive beam (e.g., a beam used to receive a sensing response to a sensing signal) and a communication receive beam (e.g., a beam used to receive a communication message) may not be the same (e.g., in direction and/or beamwidth). For example, the device may be performing a sensing procedure (e.g., listening for a response to a sensing signal) with a target device in one direction (e.g., a first angular direction) while simultaneously receiving a communication message (e.g., a data packet) from another device in a different direction (e.g., a second angular direction).

A device may utilize a single or multiple receiving radio frequency (RF) chains. For example, if two RF chains are implemented, one may be used for receiving and processing sensing signals, and the other may be used for receiving and processing communication signals. Each chain may apply the appropriate beamformer for a given direction. However, if the device is equipped with a single RF chain (e.g., the same RF chain is used for sensing and communication purposes), the RF chain may not have the capability to accommodate different sensing and communication beams at the same time (e.g., at overlapping time resources). Further, in some sidelink operations (e.g., mode 2 sidelink, out of network coverage), some UEs may be unable to coordinate resource selection with a network, which may lead to the UEs having to coordinate directly with one another (e.g., in order to accommodate conflicting (e.g., incompatible) sensing and communications beam directions).

The techniques herein enable UE coordination in sidelink operations to reduce or prevent scenarios in which a UE is performing sensing and communication operations at the same time even in cases where different beam parameters are used for sensing and communication. For example, a sensing UE may be configured to perform sensing operations and ignore a communications signal (e.g., a sidelink message) when performing transmission or reception of sensing signals as part of a sensing operation (e.g., due to being able to support operations using a single beam or beam direction). In such cases, other UEs may be aware that the sensing UE will not attempt to decode communications signals and the other UEs may refrain from transmitting communication signals (e.g., data messages or control messages) to the sensing UE (e.g., when the sensing UE is performing a sensing operation). For example, a first UE (e.g., transmitting UE) may transmit to a second UE (e.g., receiving UE) an indication of whether the first UE will attempt to decode communication signals during resources reserved for sensing purposes. Thus, the second UE may be aware if the first UE will attempt to decode during this period (e.g., the reserved resources) and may refrain from transmitting communication signals (e.g., if the first UE will refrain from decoding during the reserved resources).

Aspects of the disclosure are initially described in the context of wireless communications systems. Additional aspects of this disclosure are described in the context of RF chains, a sidelink resource pool, and process flows. Aspects of the disclosure are further illustrated by and described with reference to apparatus diagrams, system diagrams, and flowcharts that relate to techniques for sensing and communication beam conflict in sidelink.

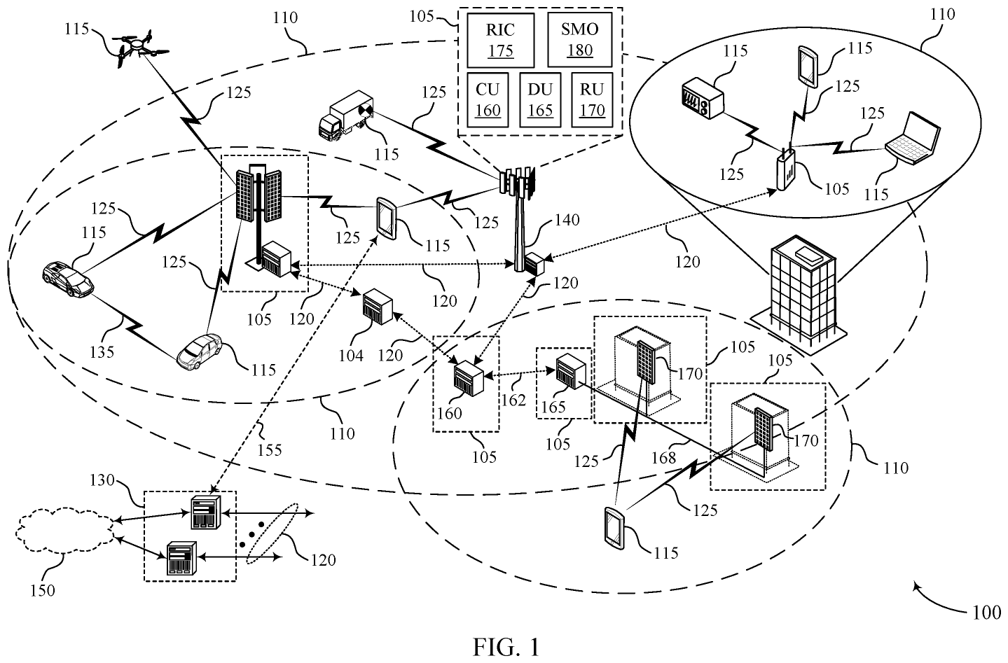

FIG. 1 shows an example of a wireless communications system 100 that supports techniques for sensing and communication beam conflict in sidelink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for sensing and communication beam conflict in sidelink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A device (e.g., UE 115) may support JCS operations. That is, the device may perform RF sensing and receive a communication signal at the same time or during at least partially overlapping time resources. For instance, in monostatic sensing (e.g., radar sensing), the device may monitor for a response to a transmitted probing signal that may be reflected by a target. Additionally, the device may perform sensing by transmitting a sensing (e.g., probing) signal and receiving (e.g., processing) a response (e.g., due to reflections from the target). In some cases, to improve spectrum efficiency, a communication node (e.g., a UE 115 or a network entity 105) may use time and frequency resources for receiving the response that were used for the transmission of the sensing signal. In these cases, a communication waveform (e.g., a waveform associated with data communications or messages) may selected over other waveforms for sensing. That is, the UE 115 or the network entity 105, may use the communication waveform for sensing purposes by reusing hardware (e.g., communication processing modules) that may be available to the devices.

In a full-duplex sensing operation, sensing reception may occur at the same time (e.g., at overlapping time resources) as transmission of a sensing signal by a sensing device (e.g., UE 115 or network entity 105). In some cases, a sensing device may apply beamforming to both a sensing transmitter and a sensing receiver to identify the angular positions of a target as part of a sensing procedure. In these cases, one option is to have the direction and beamwidth of the transmitter beam and receiver beam be the same (or have similar parameters). In such cases, a full-duplex UE 115, and thus a full-duplex operation (e.g., full-duplex sensing and full-duplex communication), may be employed. For example, a first RX beam (e.g., a sensing RX beam) may be aligned with the sensing direction of interest and a second RX beam (e.g., a communication RX beam) may be aligned with a communication link 125 direction (e.g., a D2D communication link 135). That is, a full-duplex UE 115 may perform a communication operation and a sensing operation at the same time (e.g., using at least partially overlapping time resources).

In a dual reception operation where a device is capable of performing sensing (e.g., target or radar sensing) and communication (e.g., communication of data), the sensing receive beam (e.g., a beam used to receive a sensing response to a sensing signal) and a communication receive beam (e.g., a beam used to receive a communication message) may not be the same (e.g., in direction and/or beamwidth). For example, the device may perform a sensing procedure (e.g., listening for a response to a sensing signal) with a target device in one direction (e.g., a first angular direction) while simultaneously receive a communication message (e.g., data packet) from another device (e.g., a second UE 115) in a different direction (e.g., a second angular direction).

In some cases, a device may utilize a single or multiple RF chains (e.g., panels). For example, if two RF chains are implemented, one may be used for receiving and processing sensing signals, and the other may be used for receiving and processing communication signals (e.g., sidelink signals). Each chain may apply the appropriate beamformer for a given direction. However, a device (e.g., a low cost UE 115 or a low end UE 115) may be equipped with a single RF chain (e.g., the same RF chain is used for sensing and communication purposes), and this RF chain may not have the capability to accommodate different sensing and communication beams at the same time. Further, in some sidelink operations (e.g., mode 2 sidelink operation, out of network coverage), some UEs 115 may be unable to coordinate resource selection with a network entity 105 which may lead to the UEs 115 having to coordinate directly with one another (e.g., in order to accommodate conflicting (e.g., incompatible) sensing and communications beam directions).

In some cases, the UEs 115 may coordinate in sidelink operations to reduce or prevent scenarios in which a UE 115 is performing sensing and communication operations at the same time even in cases where different beam parameters are used for sensing and communication. For example, a sensing UE 115 may be configured to perform sensing operations and ignore communication signals (e.g., a sidelink message) when performing transmission or reception sensing signals as part of a sensing operation. In such cases, other UEs 115 may be aware that the sensing UE 115 may not attempt to decode communications signals. The other UEs 115 may refrain from transmitting communication signals (e.g., data messages or control messages) to the sensing UE 115 (e.g., when the sensing UE 115 is performing a sensing operation). For example, a first UE 115 may transmit to a second UE 115 an indication of whether the first UE 115 will attempt to decode communication signals during resources reserved for sensing purposes. Thus, the second UE 115 may be aware if the first UE 115 will attempt to decode during this period (e.g., the reserved resources) and may refrain from transmitting communication signals (e.g., if the first UE will refrain from decoding during the reserved resources).

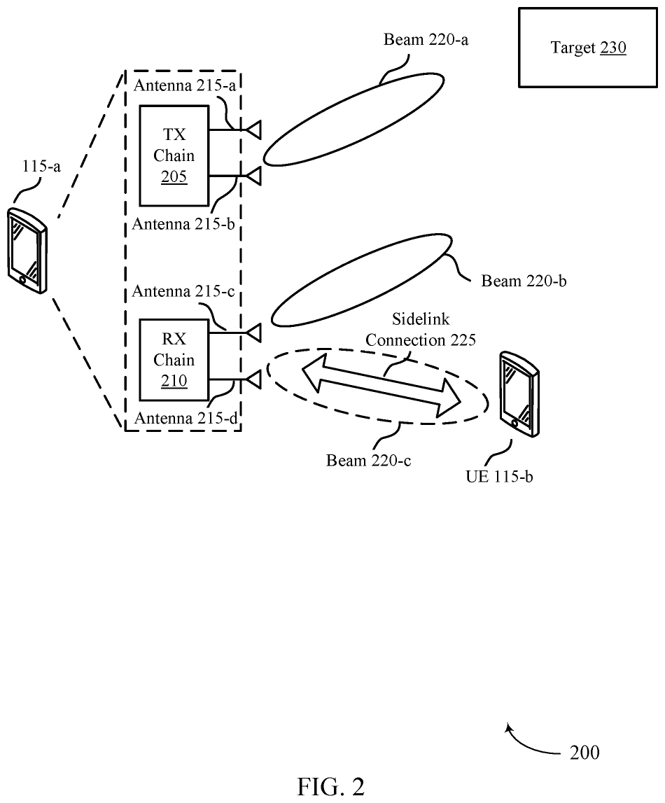

FIG. 2 shows an example of a wireless communications system 200 that supports techniques for sensing and communication beam conflict in sidelink in accordance with one or more aspects of the present disclosure. The wireless communications system 200 may implement aspects of the wireless communications system 100. For example, the wireless communications system 200 may include a UE 115-a and a UE 115-b which may each be examples of a UE 115, as described with reference to FIG. 1. The UE 115-a and the UE 115-b may communicate via a sidelink connection 225 (e.g., PC5 link), which may be an example of a D2D communication link 135, as described with reference to FIG. 1.

In some cases, the UE 115-a may have one or more transmission (TX) chains 205 (e.g., TX RF chain) and one or more RX chains 210 (e.g., RX RF chain). In the example of FIG. 2, the UE 115-a may have a single TX chain 205 and a single RX chain 210. The TX chain 205 may include multiple antennas 215 (e.g., an antenna 215-a and an antenna 215-b). Similarly, the RX chain may include multiple antennas 215 (e.g., an antenna 215-c and an antenna 215-d). The multiple antennas 215 may allow the UE 115-a to steer (e.g., direct a beam based on one or more beamforming parameters) one or more beams 220. For example, the UE 115-a may steer a TX beam (e.g., a beam 220-a), a RX sensing beam (e.g., a beam 220-b), and a RX communication beam (e.g., a beam 220-c). For example, UE 115-a may transmit a signal to the target 230 using the beam 220-a and the UE 115-a may process and receive sensing signals by the target 230 using the beam 220-b. The UE 115-a may perform communication operations in the direction of the beam 220-c. For instance, the UE 115-a may receive sidelink messages from the UE 115-b using a sidelink connection 225.

In some cases, a UE 115-a may support beamforming for sensing operations. For example, the UE 115-a may perform beam-based sensing to identify the location (e.g., angular position) and distance of a target 230. The UE 115-a may use the location and the position of the target 230 to determine polar coordinates corresponding to the target 230. Additionally, the UE 115-a may steer one or more beams 220 (e.g., using analog and digital components of the UE 115-a). The UE 115-a may include a multiple antenna architecture using digital or analog beamforming. However, a legacy communication waveform may utilize a high clock rate and analog beamforming. Thus, the UE 115-a may perform analog beamforming in a sensing operation and determine the location (e.g., extract the angular information) of the target 230 based on the direction of the sensing beam 220-b.

In a first example, the UE 115-a may apply beamforming for the TX chain 205. For example, the UE 115-a may steer the TX beam 220-a (e.g., sensing TX beam) toward a direction of interest, such as the direction of the target 230. In this example, the UE 115-a may not apply beamforming for the RX chain 210. For instance, the RX beam 220-b (e.g., sensing RX beam) may operate (e.g., may monitor) in an omni-direction fashion, where the RX beam 220-b may not be as powerful (e.g., have a large beamforming gain such as a beamforming gain above a threshold gain) as the TX beam 220-a but may cover a larger area.

In a second example, the UE 115-a may apply beamforming for the RX chain 210. For example, the UE 115-a may steer the RX beam 220-b toward a direction of interest, such as the direction of the target 230. In this example, the UE 115-a may not apply beamforming for the TX chain 205. For instance, the TX beam 220-a may operate in an omni-direction fashion, where the TX beam 220-a may not be as powerful (e.g., have a large beamforming gain) as the RX beam 220-b but may cover a larger area.

In a third example, the UE 115-a may apply beamforming for both the TX chain 205 and the RX chain 210. For example, the UE 115-a may steer both the TX beam 220-a and the RX beam 220-b toward a direction of interest, such as the direction of the target 230. In this example, the UE 115-a may steer the TX beam 220-a and the RX beam 220-b in the same direction. That is, the UE 115-a may align the directions of the TX beam 220-a and the RX beam 220-b to point to the same direction. Additionally, the TX beam 220-a and the RX beam 220-b may have the same beamwidth. Applying beamforming to both the TX beam 220-a and the RX beam 220-b may result in an optimal performance as it may provide the largest end-to-end beamforming gain. Thus, the UE 115-a may be capable of performing beamforming while transmitting and receiving when performing a sensing operation.

In some cases, the UE 115-a may be capable of performing JCS operations. That is, the UE 115-a may be capable of receiving sensing and communication signals at the same time (e.g., over overlapping time resources). As described in more detail with reference to FIG. 1, sensing nodes may operate in a full duplex implementation, where the receiver of the monostatic sensing node may operate at the same time as a transmission of the sensing signal. Similarly, the UE 115-a may support a full-duplex communication operation in addition to supporting the full-duplex sensing operation. For example, the UE 115-a may receive and process (e.g., decode) a sensing signal and communication signals (e.g., transmitted by the UE 115-b) at the same time as transmitting a sensing signal, a communication signal, or both. These signals may not interfere with one another if they each occupy different physical resource blocks.

In some cases, the UE 115-a may perform a sensing transmission scanning over multiple beams 220, where each beam direction may have an extended transmission duration, resulting in an increased integration gain. In these cases, the UE 115-a may receive sensing and communication signals at the same time. However, if the UE 115-a applies beamforming to the RX chain 210, the sensing RX beam (e.g., the beam 220-b) may not have the same beam parameters (e.g., beam direction, beam beamwidth) as the communication RX beam (e.g., the beam 220-c). For example, the UE 115-a may steer the sensing RX beam 220-b in the direction of the target 230 and steer the communication RX beam 220-c in the direction the UE 115-b (e.g., for sidelink communications).

In some cases, the UE 115-a may employ more than one RX chain 210 (e.g., RX panel). For example, the UE 115-a may use one RX chain 210 for processing and receiving sensing signals and a different RX chain 210 for processing and receiving communication signals. Thus, each RX chain 210 may apply an appropriate beamformer tailored to their respective operations.

As shown in FIG. 2, the UE 115-a may employ a single RX chain 210. In these cases, the RX chain 210, and thus the UE 115-a, may deal with conflicting sensing and communication beams at the same time. For example, the RX chain 210 may accommodate both the sensing RX beam 220-b and the communication RX beam 220-c at the same time. However, the sensing RX beam 220-b and the communication RX beam 220-c may have different beam parameters, leading to a poor performance (e.g., a poor beamforming pattern or a beamforming gain). For instance, the RX chain 210 may not be able to achieve the double-beam pattern (e.g., the sensing RX beam 220-b and the communication RX beam 220-c) illustrated in FIG. 2 with sufficient accuracy. Thus, the UE 115-a may drop either the sensing or communication operation.

In some cases, the UE 115-a and the UE 115-b may be capable of performing sidelink communications (e.g., transmitting CV2X transmissions, physical sidelink shared channel (PSSCH) transmissions, physical sidelink control channel (PSCCH) transmissions) using the sidelink connection 225. For instance, the UE 115-a and the UE 115-b may transmit or receive sidelink messages to one another over the sidelink connection 225. Additionally, the UE 115-a and the UE 115-b may not be able to communicate with a network entity. For example, the UE 115-a and the UE 115-b may be in a mode-2 sidelink or may be in out-of-network coverage. Thus, the UE 115-a and the UE 115-b may coordinate directly with one another if the UE 115-a has conflicting sensing and communication (e.g., sidelink) operations.

In some cases, the UE 115-a may be a low-end UE. In these cases, the UE 115-a may ignore, or not attempt to decode, an incoming communication signal (e.g., a sidelink message from the UE 115-b) if it is already performing a sensing operation at the same time. For example, the UE 115-a may employ a single RX chain 210 with a single RX beam 220-b. The RX beam 220-b may have a narrow beamwidth and the UE 115-a may direct the RX beam 220-b towards the target 230. Thus, an incoming sidelink message from the UE 115-b may not lie within the RX beam 220-b. Further, it may be beneficial for the UE 115-b to be aware of whether the UE 115-a will attempt to decode any sidelink messages and may refrain from transmitting the sidelink messages to the UE 115-a (e.g., if the UE 115-a will refrain from decoding reserved sidelink resources).

In some cases, the UE 115-a may perform a sensing operation over a set of sidelink resources (e.g., one or more sidelink resources). The UE 115-a may transmit, to the UE 115-b over the sidelink connection 225, a sidelink reservation message indicating that the sidelink resources are reserved for the sensing operation. Additionally, the UE 115-a may transmit an indication of whether the UE 115-a will attempt to decode communication signals (e.g., perform decoding operations for sidelink data messages from the UE 115-b) during the reserved sidelink resources. That is, the UE 115-a may indicate whether it will perform the sensing procedure and will refrain from performing the decoding operation during the reserved sidelink resources, or whether it will perform the sensing procedure while attempting to decode communication signals during the reserved sidelink resources. Thus, the UE 115-b may transmit, or refrain from transmitting, sidelink messages over the sidelink connection 225 based on the indication.

In some cases, the UE 115-a may transmit the indication via a new field in a sidelink control information (SCI) (e.g., SCI-1 or SCI-2), or a medium access control (MAC) control element (MAC-CE). Additionally, or alternatively, the UE 115-a may transmit the indication to the UE 115-b via a PC5-RRC connection (e.g., the sidelink connection 225). The indication may remail valid unless the UE 115-a transmits an RRC update reverting (e.g., canceling) the indication. In some instances, the UE 115-a and the UE 115-b may establish a unicast connection prior to the indication.

In some cases, the sidelink reservation message may reserve resources for a multiple consecutive slot transmission (MCSt) for sensing purposes. For example, the UE 115-a may perform a sensing operation with a duration longer than 1 slot. Thus, the sidelink reservation message may reserve multiple back-to-back slots for the sensing operation. In some instances, the UE 115-a may indicate, to the UE 115-b, whether it will attempt to decode communication signals using a single indication (e.g., bit value) in the sidelink reservation message that applies to all of the slots reserved for the sensing procedure.

In some other cases, the UE 115-a may indicate whether it will attempt to decode communication signals for each individual slot reserved for the sensing procedure using a bitmap. The bitmap may be the same size as the number of MCSt slots included in the sidelink reservation message. For instance, a beamwidth of the beam 220-b may be larger in certain slots, and incoming communication signals (e.g., sidelink messages from the UE 115-b) may have a larger possibility of lying withing the direction of the beam 220-b when it has an increased beamwidth. Thus, the UE 115-a may attempt to decode communication signals during the slots where the beam 220-b has an increased beamwidth.

Additionally, or alternatively, the UE 115-a may indicate to the UE 115-b whether it will attempt to decode communication signals for each individual slot reserved for the sensing procedure using a codeword from a pre-configured codebook. For example, the codeword may indicate that the UE 115-a may attempt to decode communication signals for the first half of the reserved sidelink resources and may refrain from attempting to decode communication signals for the second half of the reserved sidelink resources. The UE 115-a may include this codeword in the sidelink reservation message.

In some examples, the techniques described herein may have one or more associated advantages. For instance, the techniques described herein may improve transmission efficiency and enable coordination between a UE 115-a and a UE 115-b when the UE 115-a is performing a sensing procedure while receiving communication signals from the UE 115-b in a different direction.

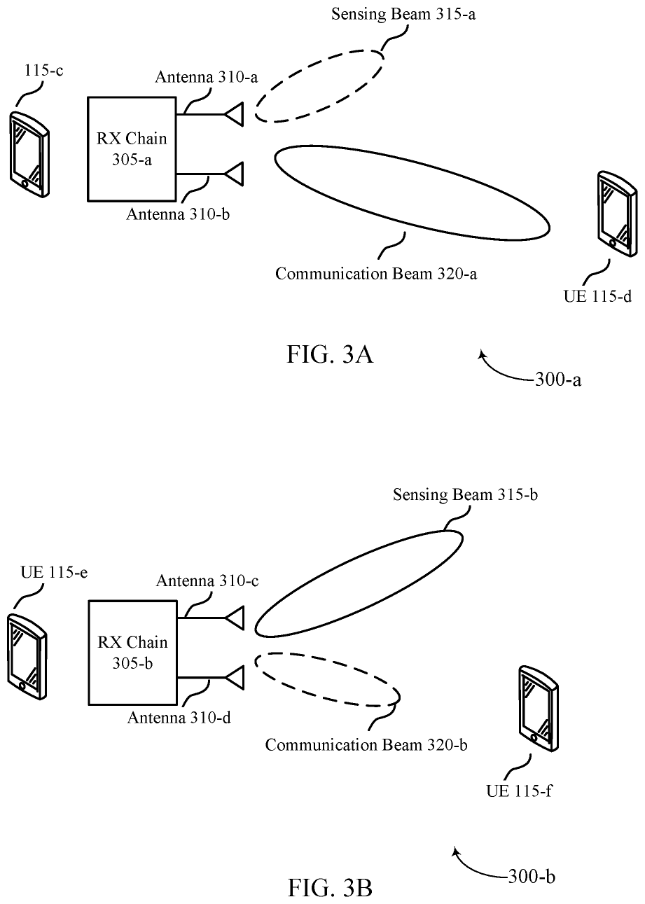

FIGS. 3A and 3B illustrate examples of wireless communication systems 300-a and 300-b that support techniques for sensing and communication beam conflict in sidelink in accordance with one or more aspects of the present disclosure. The wireless communication system 300-a and 300-b may implement aspects of the wireless communications system 100 and the wireless communications system 200.

As depicted in FIG. 3A, a UE 115-c may employ a single RX chain 305-a during sidelink resources reserved for a sensing operation. The RX chain 305-a may accommodate a double-beam pattern and include beams in different directions. The UE 115-c and the RX Chain 305-a may be examples of the UE 115-a and the RX chain 210, respectively, as described with reference to FIG. 2. The RX chain 305-a may include a multiple antenna architecture with at least an antenna 310-a and an antenna 310-b, which may be examples of the antennas 215-c and 215-d as described with reference to FIG. 2, allowing for a double-beam beamformer. That is, the RX chain 305-a may support a sensing beam 315-a and a communication beam 320-a which may be examples of the beam 220-b and the beam 220-c, respectively, as described with reference to FIG. 2.

In some cases, the RX chain 305-a may support both a sensing operation in the direction of the sensing beam 315-a and a communication operation in the direction of the communication beam 320-a. The communication operation may include receiving sidelink messages from a UE 115-d, which may be an example of the UE 115-b as described with reference to FIG. 2. That is, the UE 115-c may perform a sensing operation at the same time as receiving, and attempting to decode, sidelink messages from the UE 115-d. However, if the RX chain 305-a, employs a double-beam beamformer, the UE 115-c may apply a beamforming gain to receiving sensing signals (e.g., in the direction of beam 315-a), communication signals (in the direction of the communication beam 320-a), or both.

In some cases, the UE 115-c may apply a beamforming gain to the sensing operation, the communication operation, or both. If the sensing operation and the communication operation are treated equally, both operations may experience the same beamforming gain. For instance, the sensing operation and the communication operation may experience a loss of up to 3 decibels (dB) in receiving beamforming gain when compared to the beamforming gain experienced when the UE 115-c employs a single beam. The beamforming gain may depend on how different the direction of the sensing beam 315-a is from the direction of the communication beam 320-a.

In some cases, the UE 115-c may prioritize the communications operation in the direction of the communication beam 320-a over the sensing operation in the direction of the sensing beam 315-a. That is, the UE 115-c may increase the beamforming gain loss for the sensing operation in order to reduce the beamforming gain loss for the communication operation.

As depicted in FIG. 3B, a UE 115-e may employ a single RX chain 305-b during sidelink resources reserved for a sensing operation. The RX chain 305-a may accommodate a double-beam pattern and include beams in different directions. The UE 115-e and the RX chain 305-b may be examples of the UE 115-a and the RX chain 210, respectively, as described with reference to FIG. 2. For example, the RX chain 305-b may include a multiple antenna architecture with at least an antenna 310-c and an antenna 310-d, which may be examples of the antennas 215-c and 215-d as described with reference to FIG. 2, allowing for a double-beam beamformer. That is, the RX chain 305-b may support both a sensing beam 315-b and a communication beam 320-b which may be examples of the beam 220-b and the beam 220-c, respectively, as described with reference to FIG. 2.

Similar to the RX chain 305-a, the RX chain 305-b may support both a sensing operation in the direction of the sensing beam 315-b and a communication operation in the direction of the communication beam 320-a. The communication operation may include receiving sidelink messages from a UE 115-f, which may be an example of the UE 115-b as described with reference to FIG. 2.

In some cases, the UE 115-e may prioritize the sensing operation in the direction of the sensing beam 315-b over the communications operation in the direction of the communication beam 320-b. That is, the UE 115-e may increase the beamforming gain loss for the communication operation in order to reduce the beamforming gain loss for the sensing operation. Additionally, it may be useful for the UE 115-f to know the beamforming gain for the communication operation. Thus, the UE 115-f would know the beamforming gain experienced by any potential sidelink transmissions transmitted to the UE 115-e in the direction of the communication beam 320-b.

In some cases, the UE 115-e may indicate, to the UE 115-f, the beamforming gain for the communication operation. In other words, the UE 115-e may indicate, to the UE 115-f, the beamforming gain applied to a reception of sidelink messages from the UE 115-f during sidelink resources reserved by the UE 115-e (e.g., for the sensing operation). The UE 115-e may transmit, to the UE 115-f, an indication of the beamforming gain (e.g., dBs of beamforming gain) applied to the communication operation explicitly.

In some cases, the UE 115-e may transmit, to the UE 115-f, the indication of the beamforming gain (e.g., in dBs of beamforming gain) applied to the communication operation as a gain offset. For example, the UE 115-e may indicate the gain offset with respect to a pre-configured nominal gain value. The UE 115-e may indicate the gain offset via an RRC connection (e.g., to the UE 115-f). Alternatively, the UE 115-e may indicate the gain offset with respect to a maximum gain value that the RX chain 305-b can achieve. The maximum performing gain value may depend on the number of antennas (e.g., the antenna 310-c and the antenna 310-d) that correspond the RX chain 305-b. The UE 115-e may communicate the maximum gain value using an established RRC connection. Otherwise, the maximum gain value may not be known by other UEs (e.g., the UE 115-f).

In some cases, the UE 115-e may indicate the beamforming gain applied to the communication operation. For instance, the UE 115-e may indicate the beamforming gain as part of a sidelink reservation message (e.g., via SCI-1, SCI-2, or MAC-CE). The sidelink reservation message is described in more detail with respect to FIG. 2. Additionally, or alternatively, the UE 115-e may indicate the beamforming gain for each slot when the sidelink reservation message includes MCSt. For example, the UE 115-e may use the same techniques for indicating the beamforming gain as it does for indicating whether the UE 115-e will attempt to decode communication signals as described in more detail with respect to FIG. 2. In other examples, the UE 115-e may indicate the beamforming gain via a PC5-RRC connection with the UE 115-f. The UE 115-e and the UE 115-f may have a previously established unicast connection.

In some cases, the UE 115-e may indicate beam parameters (e.g., beam direction, beamwidth, or any combination thereof), in addition to the beamforming gain, associated with the communication beam 320-b, the sensing beam 315-b, or both. For instance, the UE 115-e may indicate the beamforming gain for the communication operation, as well as the direction the beamforming gain applies to. Thus, the UE 115-f may receive an indication of a beamforming gain applied to the communication operation (e.g., by the UE 115-e) and the beam parameters associated with the communication beam 320-b. In some instances, the UE 115-f may determine that the beamforming gain is applied to all receiving directions (e.g., the sensing beam 315-b and the communication beam 320-b) if the beam parameter information is not available to the UE 115-f.

In a first example, the UE 115-e may indicate the beam parameters explicitly as an interval of angles (e.g., a minimum and a maximum angle). Beams with directions that lie within the interval of angles may experience the indicated beamforming gain. That is, the indicated beamforming gain may be the least possible beamforming gain experienced by a beam that lies within the interval of angles. The UE 115-e may indicate the interval as angular values with respect to a global angular reference system (e.g., cardinal directions) that is known by other UEs (e.g., the UE 115-f).

In a second example, the UE 115-e may indicate the beam parameters as a set of one or more transmission configuration indication (TCI) states. For instance, the UE 115-e may indicate the beam parameters as a set of TCI states over a link (e.g., PC5-RRC link). The UE 115-e and the UE 115-f may have previously established the link. The TCI states may correspond to the direction of the communication beam 320-b. Thus, the UE 115-f may assume that the indicated beamforming gain applies to the directions of the beams corresponding to the indicated TCI states. The indicated TCI states may be selected as one or more TCI states from a pre-configured set of TCI states.

In some cases, the UE 115-f may receive an indication of the beamforming gain, beam parameters, or both, associated with the communication beam 320-b, from the UE 115-e. The UE 115-f may thus decide whether to transmit sidelink messages, to the UE 115-e, while the UE 115-e is performing sidelink operations using the indicated beamforming gain, the beam parameters, or a combination thereof, of the communication beam 320-b.

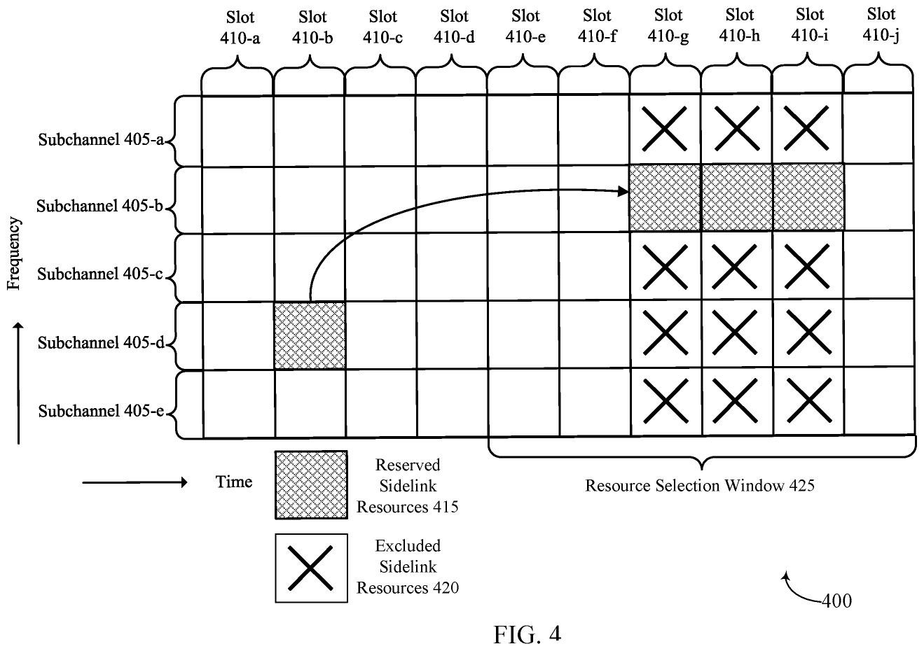

FIG. 4 shows an example of a sidelink resource pool 400 that illustrates resources for sensing and communication beam conflict in sidelink in accordance with one or more aspects of the present disclosure. The sidelink resource pool 400 may implement aspects of the wireless communications system 100, the wireless communications system 200, and the wireless communications system 300. For example, the sidelink resource pool 400 may be used to minimize losses and improve transmission efficiency associated with conflicting sensing RX beams and communication RX beam requirements.

In some cases, the sidelink resource pool 400 may include time-frequency resources. For example, the sidelink resources may span over one or more subchannels (e.g., a subchannel 405-a, a subchannel 405-b, a subchannel 405-c, a subchannel 405-d, a subchannel 405-e) and across one or more slots (e.g., a slot 410-a, a slot 410-b, a slot 410-c, a slot 410-d, a slot 410-e, a slot 410-f, a slot 410-g, a slot 410-h, a slot 410-i, a slot 410-j). In some instances, a first UE (e.g., the UE 115-b as described with reference to FIG. 2) may receive a sidelink reservation message from a second UE (e.g., the UE 115-a as described with reference to FIG. 1). The sidelink reservation message may indicate sidelink resources that are reserved (e.g., reserved sidelink resources 415) for a sensing operation at the second UE.

In a full-duplex operation, the first UE may select any sidelink resource in an available resource window (e.g., a resource selection window 425) without concerns about the second UE being in a transmit mode. For example, the first UE may select sidelink resources for a transmission towards the second UE. However, the second UE may be a low-end UE. In some instances, the second UE may not be able to efficiently receive communications while performing sensing transmissions. Thus, the first UE may account for any reserved sidelink resources 415 and exclude certain resource (e.g., excluded resources 420 and the reserved sidelink resources 415). That is, the first UE may refrain from transmitting sidelink messages to the second UE during the reserved sidelink resources 415 and the excluded resources 420.

In some cases, the first UE may trigger a resource selection procedure. For example, the first UE may exclude sidelink resources for the transmission of sidelink messages in slots that have one or more reserved sidelink resources 415 from its resource selection window. The second UE may transmit the sidelink reservation message indicating that the reserved sidelink resources 415 are reserved for a sensing operation. The second UE may further indicate if it will attempt to receive or decode any communication signals (e.g., sidelink messages) during these reserved sidelink resources 415. Additionally, or alternatively, the first UE may determine that the second UE may not receive sidelink messages successfully as a result of a beamforming gain (e.g., the beamforming gain exceeds a threshold). As a result, the first UE may exclude sidelink resources that share a slot with the reserved sidelink resources 415 in the resource selection window 425.

As illustrated in FIG. 4, the second UE may transmit the sidelink reservation message over the sidelink resource occupying the subchannel 405-d and the slot 410-b. The sidelink reservation message may indicate that the sidelink resources occupying the subchannel 405-b and spanning the slot 410-g, the slot 410-h, and the slot 410-i are reserved sidelink resources 415. The first UE may exclude the sidelink resources (e.g., the excluded sidelink resources 420) corresponding to any subchannel that occupy the slot 410-g, the slot 410-h, or the slot 410-i. The first UE may also exclude any sidelink resources that have been reserved by other UEs. In some instances, the first UE may select an available sidelink resource for transmitting sidelink messages. The available sidelink resource may be a sidelink resource in the resource selection window 425 that is not part of the reserved sidelink resources 415 or the excluded sidelink resources 420.

In some cases, the first UE may select one or more of the excluded sidelink resources 420 for the transmission of sidelink messages. For example, the quantity of the original sidelink resources may be too low (e.g., below a threshold). In these cases, the first UE may apply a ranking to the excluded sidelink resources 420. For instance, the first UE may apply a reference signal received power (e.g., RSRP) based ranking and treat the excluded sidelink resources 420 as if they had been reserved by a virtual reservation signal.

In some cases, the excluded sidelink resources 420 may have a corresponding RSRP and priority value. In some instances, the RSRP value and the priority value may be pre-configured. Additionally, or alternatively, the RSRP value and the priority value may depend on the communication beamforming capabilities of the second UE. The second UE may indicate its communication beamforming capabilities in the sidelink reservation message via a pre-configured mapping. Additionally, or alternatively, first UE may assign the RSRP value and the priority value. Additionally, or alternatively, the RSRP value and the priority value may be the same as a RSRP value and a priority value corresponding to the reserved sidelink resources 415. For instance, the excluded sidelink resources 420 in the slot 410-g may have the same RSRP value and priority value as the reserved sidelink resource 415 in the slot 410-g (e.g., same slot). Thus, the first UE may select one or more previously excluded sidelink resources 420 for the transmission of sidelink messages to the second UE. In other words, the first UE may transmit sidelink messages over sidelink resources that share a slot 410 with a reserved sidelink resource 415.

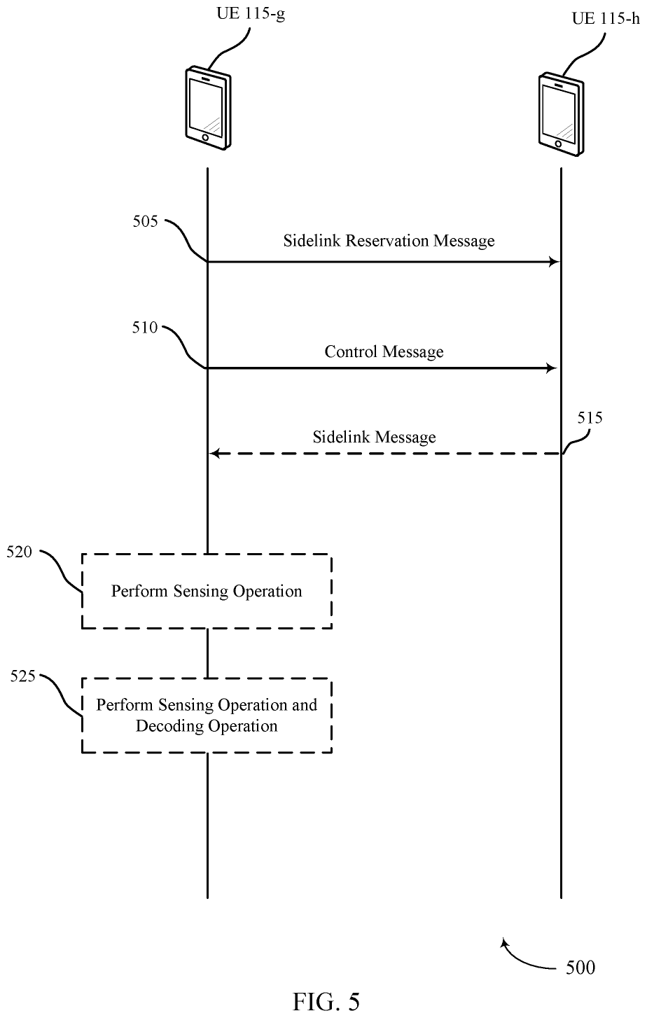

FIG. 5 shows an example of a process flow 500 that supports techniques for sensing and communication beam conflict in sidelink in accordance with one or more aspects of the present disclosure. The process flow 500 may implement aspects the wireless communications system 100, the wireless communications system 200, the wireless communications system 300, and the sidelink resource pool 400 described with reference to FIGS. 1 through 4. The process flow 500 may be based on communication between a UE 115-g and a UE 115-h, which may be examples of the UE 115-a and the UE 115-b, respectively, as described with reference to FIG. 2. The process flow 500 may be implemented by the UE 115-g and the UE 115-h to minimize losses and improve transmission efficiency associated with conflicting sensing and communication receiving beam requirements, among other benefits.

In the following description of the process flow 500, the operations between the UE 115-g and the UE 115-h may be transmitted in a different order than the example order shown, or the operations performed by the UE 115-g and the UE 115-h may be performed in different orders or at different times. Some operations may also be omitted from the process flow 500, and other operations may be added to the process flow 500.

At 505, the UE 115-g may transmit a sidelink reservation message to the UE 115-h. For example, the sidelink reservation message may indicate sidelink resources that are reserved for a sensing operation at the UE 115-g. In some cases, the sidelink reservation message may indicate whether the UE 115-g will perform one or more decoding operations (e.g., on sidelink messages received from the UE 115-h) during the sidelink resources reserved for the sensing operation.

At 510, the UE 115-g may transmit a control message to the UE 115-h. The control message may indicate whether the UE 115-g will perform one or more decoding operations (e.g., on sidelink messages received from the UE 115-h) during the sidelink resources reserved for the sensing operation.

At 520, the UE 115-g may perform a sensing operation during the sidelink resources reserved for the sensing operation based on the control message indicating that the UE 115-g will perform a sensing operation during the reserved sidelink resources. The UE 115-g may perform the sensing operation based on having the communication beamforming capability to successfully perform the sensing operation (e.g., and not to successfully receive sidelink messages) during the reserved sidelink resources.

At 525, the UE 115-g may perform a sensing operation and one or more decoding operations during the sidelink resources reserved for the sensing operation based on the control message indicating that the UE 115-g will perform the sensing operation and the one or more decoding operations during the reserved sidelink resources. The UE 115-g may perform the sensing operation and the decoding operations based on having the communication beamforming capability to successfully receive sidelink messages during the reserved sidelink resources.

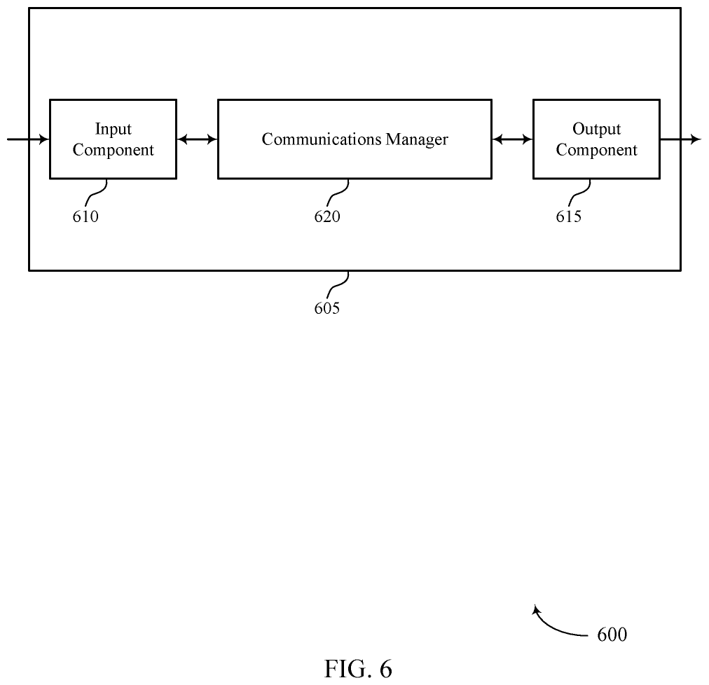

FIG. 6 shows a block diagram 600 of a device 605 that supports methods for techniques for sensing and communication beam conflict in sidelink in accordance with one or more aspects of the present disclosure. The device 605 may be an example of aspects of a UE 115 as described herein. The device 605 may include an input component 610, an output component 615, and a communications manager 620. The device 605 may also include a processor. Each of these components may be in communication with one another (e.g., via one or more buses).

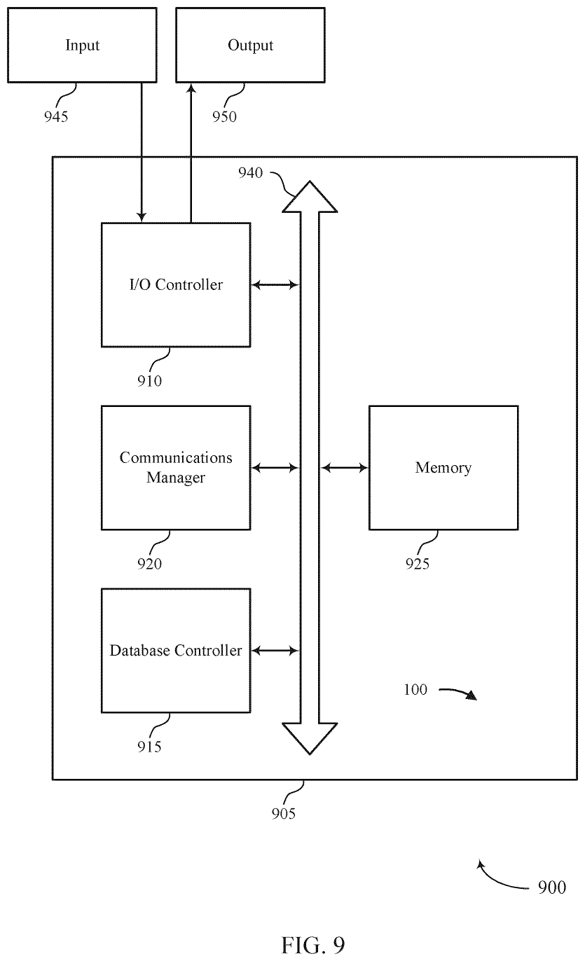

The input component 610 may manage input signals for the apparatus 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the apparatus 605 for processing. For example, the input component 610 may transmit input signals to the communications manager 620 to support methods for techniques for sensing and communication beam conflict in sidelink. In some cases, the input component 610 may be a component of an input/output (I/O) controller 910 as described with reference to FIG. 9.

The output component 615 may manage output signals for the apparatus 605. For example, the output component 615 may receive signals from other components of the apparatus 605, such as the communications manager 620, and may transmit these signals to other components or devices. In some specific examples, the output component 615 may transmit output signals for display in a user interface, for storage in a database or data store, for further processing at a server or server cluster, or for any other processes at any number of devices or systems. In some cases, the output component 615 may be a component of an I/O controller 910 as described with reference to FIG. 9.

The communications manager 620, the input component 610, the output component 615, or various combinations thereof or various components thereof may be examples of means for performing various aspects of methods for techniques for sensing and communication beam conflict in sidelink as described herein. For example, the communications manager 620, the input component 610, the output component 615, or various combinations or components thereof may support a method for performing one or more of the functions described herein.

In some examples, the communications manager 620, the input component 610, the output component 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the input component 610, the output component 615, or various combinations or components thereof may be implemented in code (e.g., as communications management software or firmware) executed by a processor. If implemented in code executed by a processor, the functions of the communications manager 620, the input component 610, the output component 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the input component 610, the output component 615, or both. For example, the communications manager 620 may receive information from the input component 610, send information to the output component 615, or be integrated in combination with the input component 610, the output component 615, or both to obtain information, output information, or perform various other operations as described herein.

The communications manager 620 may support wireless communications at a first UE in accordance with examples as disclosed herein. For example, the communications manager 620 is capable of, configured to, or operable to support a means for transmitting a sidelink reservation message that indicates a set of sidelink resources reserved for a sensing operation for the first UE. The communications manager 620 is capable of, configured to, or operable to support a means for transmitting a control message indicating whether the first UE will perform one or more decoding operations for one or more sidelink data messages during the set of sidelink resources reserved for the sensing operation. The communications manager 620 is capable of, configured to, or operable to support a means for performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

Additionally, or alternatively, the communications manager 620 may support wireless communications at a first UE in accordance with examples as disclosed herein. For example, the communications manager 620 is capable of, configured to, or operable to support a means for receiving a sidelink reservation message that indicates a set of sidelink resources reserved for a sensing operation at a second UE. The communications manager 620 is capable of, configured to, or operable to support a means for receiving a control message indicating whether the second UE will perform one or more decoding operations for one or more sidelink data messages during the set of sidelink resources reserved for the sensing operation. The communications manager 620 is capable of, configured to, or operable to support a means for transmitting an indication of one or more sidelink resources selected for transmission of the one or more sidelink data messages, to the second UE, based on the control message.

By including or configuring the communications manager 620 in accordance with examples as described herein, the device 605 (e.g., a processor controlling or otherwise coupled with the input component 610, the output component 615, the communications manager 620, or a combination thereof) may support techniques for more efficient utilization of communication resources.

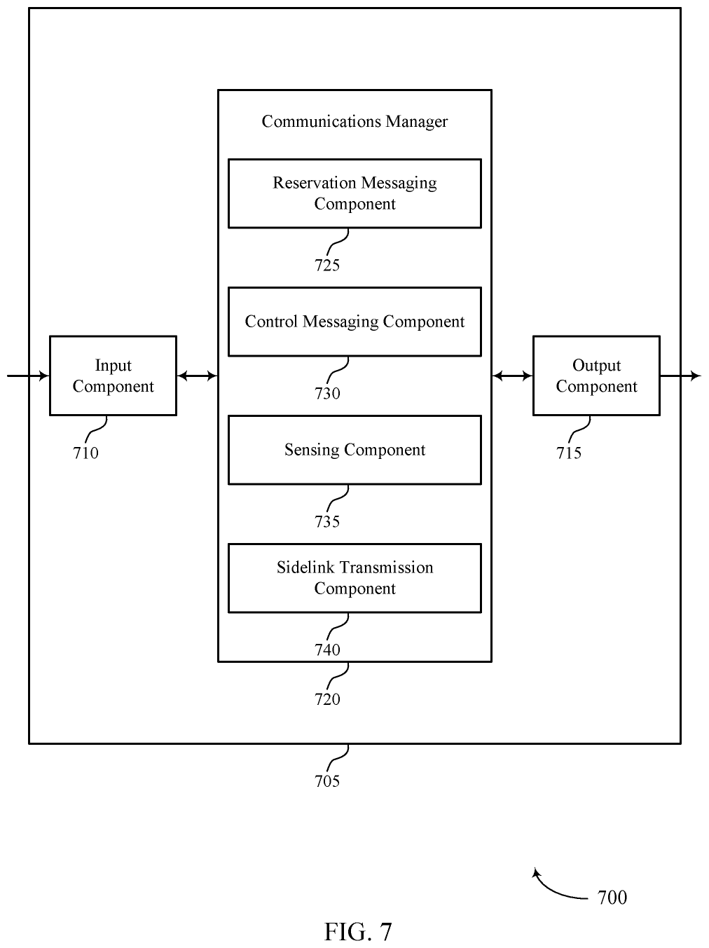

FIG. 7 shows a block diagram 700 of a device 705 that supports methods for techniques for sensing and communication beam conflict in sidelink in accordance with one or more aspects of the present disclosure. The device 705 may be an example of aspects of a device 605 or a UE 115 as described herein. The device 705 may include an input component 710, an output component 715, and a communications manager 720. The device 705 may also include a processor. Each of these components may be in communication with one another (e.g., via one or more buses).

The input component 710 may manage input signals for the apparatus 705. For example, the input component 710 may identify input signals based on an interaction with a modem, a keyboard, a mouse, a touchscreen, or a similar device. These input signals may be associated with user input or processing at other components or devices. In some cases, the input component 710 may utilize an operating system such as iOS®, ANDROID®, MS-DOS®, MS-WINDOWS®, OS/2®, UNIX®, LINUX®, or another known operating system to handle input signals. The input component 710 may send aspects of these input signals to other components of the apparatus 705 for processing. For example, the input component 710 may transmit input signals to the communications manager 720 to support methods for techniques for sensing and communication beam conflict in sidelink. In some cases, the input component 710 may be a component of an I/O controller 910 as described with reference to FIG. 9.

The output component 715 may manage output signals for the apparatus 705. For example, the output component 715 may receive signals from other components of the apparatus 705, such as the communications manager 720, and may transmit these signals to other components or devices. In some specific examples, the output component 715 may transmit output signals for display in a user interface, for storage in a database or data store, for further processing at a server or server cluster, or for any other processes at any number of devices or systems. In some cases, the output component 715 may be a component of an I/O controller 910 as described with reference to FIG. 9.

The device 705, or various components thereof, may be an example of means for performing various aspects of methods for techniques for sensing and communication beam conflict in sidelink as described herein. For example, the communications manager 720 may include a reservation messaging component 725, a control messaging component 730, a sensing component 735, a sidelink transmission component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the input component 710, the output component 715, or both. For example, the communications manager 720 may receive information from the input component 710, send information to the output component 715, or be integrated in combination with the input component 710, the output component 715, or both to obtain information, output information, or perform various other operations as described herein.

The communications manager 720 may support wireless communications at a first UE in accordance with examples as disclosed herein. The reservation messaging component 725 is capable of, configured to, or operable to support a means for transmitting a sidelink reservation message that indicates a set of sidelink resources reserved for a sensing operation for the first UE. The control messaging component 730 is capable of, configured to, or operable to support a means for transmitting a control message indicating whether the first UE will perform one or more decoding operations for one or more sidelink data messages during the set of sidelink resources reserved for the sensing operation. The sensing component 735 is capable of, configured to, or operable to support a means for performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

Additionally, or alternatively, the communications manager 720 may support wireless communications at a first UE in accordance with examples as disclosed herein. The reservation messaging component 725 is capable of, configured to, or operable to support a means for receiving a sidelink reservation message that indicates a set of sidelink resources reserved for a sensing operation at a second UE. The control messaging component 730 is capable of, configured to, or operable to support a means for receiving a control message indicating whether the second UE will perform one or more decoding operations for one or more sidelink data messages during the set of sidelink resources reserved for the sensing operation. The sidelink transmission component 740 is capable of, configured to, or operable to support a means for transmitting an indication of one or more sidelink resources selected for transmission of the one or more sidelink data messages, to the second UE, based on the control message.

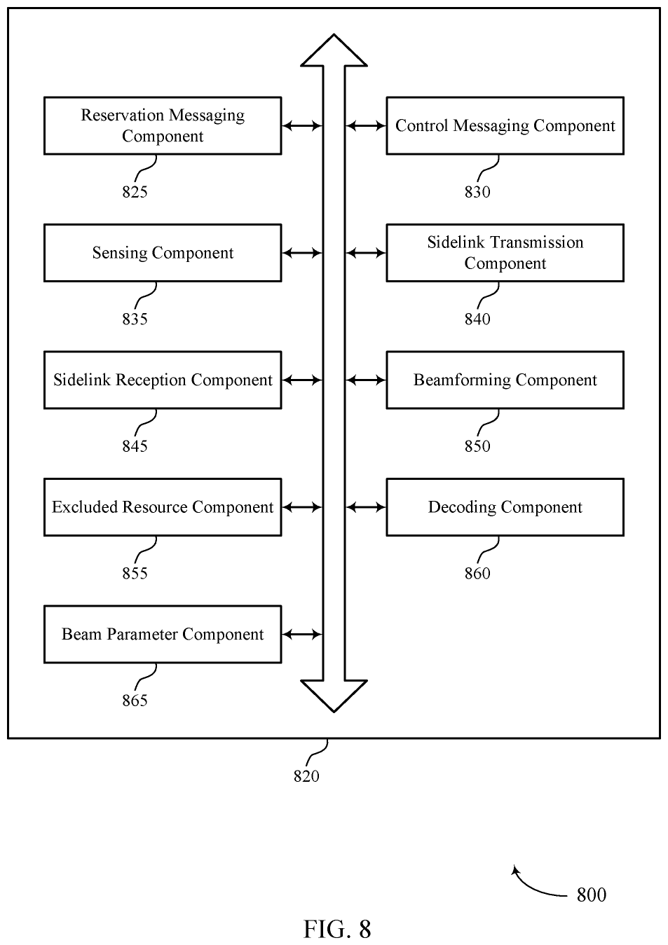

FIG. 8 shows a block diagram 800 of a communications manager 820 that supports methods for techniques for sensing and communication beam conflict in sidelink in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for sensing and communication beam conflict in sidelink as described herein. For example, the communications manager 820 may include a reservation messaging component 825, a control messaging component 830, a sensing component 835, a sidelink transmission component 840, a sidelink reception component 845, a beamforming component 850, an excluded resource component 855, a decoding component 860, a beam parameter component 865, or any combination thereof. Each of these components may communicate, directly or indirectly, with one another (e.g., via one or more buses).

The communications manager 820 may support wireless communications at a first UE in accordance with examples as disclosed herein. The reservation messaging component 825 is capable of, configured to, or operable to support a means for transmitting a sidelink reservation message that indicates a set of sidelink resources reserved for a sensing operation for the first UE. The control messaging component 830 is capable of, configured to, or operable to support a means for transmitting a control message indicating whether the first UE will perform one or more decoding operations for one or more sidelink data messages during the set of sidelink resources reserved for the sensing operation. The sensing component 835 is capable of, configured to, or operable to support a means for performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

In some examples, the sidelink reception component 845 is capable of, configured to, or operable to support a means for receiving a second message that indicates a second set of sidelink resources scheduled for the one or more sidelink data messages for reception, by the first UE, using one or more first beam parameters corresponding to a first beam direction, where the second set of sidelink resources at least partially overlaps the set of sidelink resources reserved for the sensing operation, and where the sensing operation is associated with one or more second beam parameters corresponding to a second beam direction.

In some examples, to support performing the sensing operation and the one or more decoding operations, the sidelink reception component 845 is capable of, configured to, or operable to support a means for receiving the one or more sidelink data messages during the second set of sidelink resources based on receiving the second message. In some examples, to support performing the sensing operation and the one or more decoding operations, the decoding component 860 is capable of, configured to, or operable to support a means for decoding the one or more sidelink data messages during the second set of sidelink resources.

In some examples, to support transmitting the control message, the control messaging component 830 is capable of, configured to, or operable to support a means for transmitting the control message indicating that the first UE will perform sensing and will refrain from performing the one or more decoding operations during the set of sidelink resources based on the one or more first beam parameters being different from the one or more second beam parameters.

In some examples, the set of sidelink resources reserved for the sensing operation includes multiple consecutive slots.

In some examples, to support transmitting the control message, the control messaging component 830 is capable of, configured to, or operable to support a means for transmitting an indication that the first UE will perform one or more decoding operations for one or more sidelink data messages for all slots of the multiple consecutive slots.

In some examples, to support transmitting the control message, the control messaging component 830 is capable of, configured to, or operable to support a means for transmitting an indication of whether the first UE will perform the one or more decoding operations for the one or more sidelink data messages for each slot of the multiple consecutive slots.

In some examples, to support performing the sensing operation and the one or more decoding operations, the beamforming component 850 is capable of, configured to, or operable to support a means for applying a reception beamforming gain for reception of the one or more sidelink data messages during the set of sidelink resources reserved for the sensing operation.

In some examples, the beamforming component 850 is capable of, configured to, or operable to support a means for transmitting an indication of the reception beamforming gain applied to the one or more sidelink data messages.

In some examples, to support transmitting the indication of the reception beamforming gain, the beamforming component 850 is capable of, configured to, or operable to support a means for transmitting a gain offset that is indicative of the reception beamforming gain applied to the one or more sidelink data messages.

In some examples, to support transmitting the indication of the reception beamforming gain, the beamforming component 850 is capable of, configured to, or operable to support a means for transmitting the indication of the reception beamforming gain via the sidelink reservation message or via a PC5-RRC connection.

In some examples, to support transmitting the indication of the reception beamforming gain, the beam parameter component 865 is capable of, configured to, or operable to support a means for transmitting an indication of one or more beam parameters corresponding to a beam direction that is associated with the one or more decoding operations.

In some examples, to support transmitting the indication of the one or more beam parameters, the beam parameter component 865 is capable of, configured to, or operable to support a means for transmitting an indication of an angle interval as part of the indication of the one or more beam parameters.

In some examples, to support transmitting the indication of the one or more beam parameters, the beam parameter component 865 is capable of, configured to, or operable to support a means for transmitting an indication of a set of one or more transmission configuration indication states as part of the one or more beam parameters.

In some examples, to support transmitting the control message, the control messaging component 830 is capable of, configured to, or operable to support a means for transmitting the control message via a sidelink control information message or via a medium access control (MAC) control element (MAC-CE).

Additionally, or alternatively, the communications manager 820 may support wireless communications at a first UE in accordance with examples as disclosed herein. In some examples, the reservation messaging component 825 is capable of, configured to, or operable to support a means for receiving a sidelink reservation message that indicates a set of sidelink resources reserved for a sensing operation at a second UE. In some examples, the control messaging component 830 is capable of, configured to, or operable to support a means for receiving a control message indicating whether the second UE will perform one or more decoding operations for one or more sidelink data messages during the set of sidelink resources reserved for the sensing operation. The sidelink transmission component 840 is capable of, configured to, or operable to support a means for transmitting an indication of one or more sidelink resources selected for transmission of the one or more sidelink data messages, to the second UE, based on the control message.

In some examples, to support transmitting the indication of the one or more sidelink resources selected for the transmission of the one or more sidelink data messages, the sidelink transmission component 840 is capable of, configured to, or operable to support a means for transmitting, to the second UE, the indication of the one or more sidelink resources selected for the transmission of the one or more sidelink data messages, where the one or more sidelink resources are selected based on exclusion of one or more sidelink resources of the set of sidelink resources reserved for the sensing operation at the second UE, where the one or more sidelink resources are excluded from the set of sidelink resources based on the control message indicating that the first UE will perform sensing and will refrain from performing the one or more decoding operations during the set of sidelink resources.

In some examples, the beamforming component 850 is capable of, configured to, or operable to support a means for receiving, from the second UE, an indication of a reception beamforming gain for the one or more sidelink data messages, an indication of one or more beam parameters corresponding to a beam direction, the beam direction associated with the one or more decoding operations, or a combination thereof.

In some examples, to support receiving the indication of the one or more beam parameters, the beam parameter component 865 is capable of, configured to, or operable to support a means for receiving an indication of an angle interval as part of the indication of the one or more beam parameters.

In some examples, to support transmitting the indication of the one or more sidelink resources selected for the transmission of the one or more sidelink data messages, the sidelink transmission component 840 is capable of, configured to, or operable to support a means for transmitting, to the second UE, the indication of the one or more sidelink resources selected for the transmission of the one or more sidelink data messages, where the one or more sidelink resources are selected based on exclusion of one or more sidelink resources of the set of sidelink resources reserved for the sensing operation at the second UE, where the one or more sidelink resources are excluded from the set of sidelink resources based on the indication of the reception beamforming gain, the indication of the one or more beam parameters, or a combination thereof.

In some examples, the one or more sidelink resources are excluded from the set of sidelink resources based on the reception beamforming gain exceeding a threshold.

In some examples, the excluded resource component 855 is capable of, configured to, or operable to support a means for excluding one or more sidelink resources from a window used for selecting the one or more sidelink resources selected for the transmission of the one or more sidelink data messages. In some examples, the sidelink transmission component 840 is capable of, configured to, or operable to support a means for including the one or more sidelink resources in the one or more sidelink resources selected for the transmission of the one or more sidelink data messages based on a quantity of resources within the window being below a threshold.

In some examples, to support selecting the one or more excluded resources, the excluded resource component 855 is capable of, configured to, or operable to support a means for selecting the one or more excluded resources based on a reference signal received power associated with each of the one or more excluded resources, a priority value associated with each of the one or more excluded resources, or a combination thereof.

In some examples, the reference signal received power and the priority value are based on one or more beamforming capabilities indicated by the sidelink reservation message. In some examples, the one or more excluded resources are associated with one or more sidelink resources of the set of sidelink resources reserved for the sensing operation at the second UE.

In some examples, the sidelink transmission component 840 is capable of, configured to, or operable to support a means for transmitting the one or more sidelink data messages during the set of sidelink resources reserved for the sensing operation based on the control message indicating that the second UE will perform the one or more decoding operations during the set of sidelink resources.

In some examples, the sidelink transmission component 840 is capable of, configured to, or operable to support a means for refraining from transmitting the one or more sidelink data messages during the set of sidelink resources reserved for the sensing operation based on the control message indicating that the second UE will perform sensing and will refrain from performing the one or more decoding operations during the set of sidelink resources.

FIG. 9 shows a diagram of a system 900 including a device 905 that supports techniques for sensing and communication beam conflict in sidelink in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor. In some examples, a user may interact with the device 905 via the I/O controller 910 or via hardware components controlled by the I/O controller 910.

The database controller 915 may manage data storage and processing in a database 935. The database 935 may be external to the device 905, temporarily or permanently connected to the device 905, or a data storage component of the device 905. In some cases, a user may interact with the database controller 915. In some other cases, the database controller 915 may operate automatically without user interaction. The database 935 may be an example of a persistent data store, a single database, a distributed database, multiple distributed databases, a database management system, or an emergency backup database.

Memory 925 may include random-access memory (RAM) and read-only memory (ROM). The memory 925 may store computer-readable, computer-executable software including instructions that, when executed, cause the processor to perform various functions described herein. In some cases, the memory 925 may contain, among other things, a basic I/O system (BIOS) which may control basic hardware or software operation such as the interaction with peripheral components or devices.

The processor 930 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In some other cases, a memory controller may be integrated into the processor 930. The processor 930 may be configured to execute computer-readable instructions stored in memory 925 to perform various functions (e.g., functions or tasks supporting techniques for sensing and communication beam conflict in sidelink).

The communications manager 920 may support wireless communications at a first UE in accordance with examples as disclosed herein. For example, the communications manager 920 is capable of, configured to, or operable to support a means for transmitting a sidelink reservation message that indicates a set of sidelink resources reserved for a sensing operation for the first UE. The communications manager 920 is capable of, configured to, or operable to support a means for transmitting a control message indicating whether the first UE will perform one or more decoding operations for one or more sidelink data messages during the set of sidelink resources reserved for the sensing operation. The communications manager 920 is capable of, configured to, or operable to support a means for performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources.

Additionally, or alternatively, the communications manager 920 may support wireless communications at a first UE in accordance with examples as disclosed herein. For example, the communications manager 920 is capable of, configured to, or operable to support a means for receiving a sidelink reservation message that indicates a set of sidelink resources reserved for a sensing operation at a second UE. The communications manager 920 is capable of, configured to, or operable to support a means for receiving a control message indicating whether the second UE will perform one or more decoding operations for one or more sidelink data messages during the set of sidelink resources reserved for the sensing operation. The communications manager 920 is capable of, configured to, or operable to support a means for transmitting an indication of one or more sidelink resources selected for transmission of the one or more sidelink data messages, to the second UE, based on the control message.

By including or configuring the communications manager 920 in accordance with examples as described herein, the device 905 may support techniques for more efficient utilization of communication resources and improved coordination between devices.

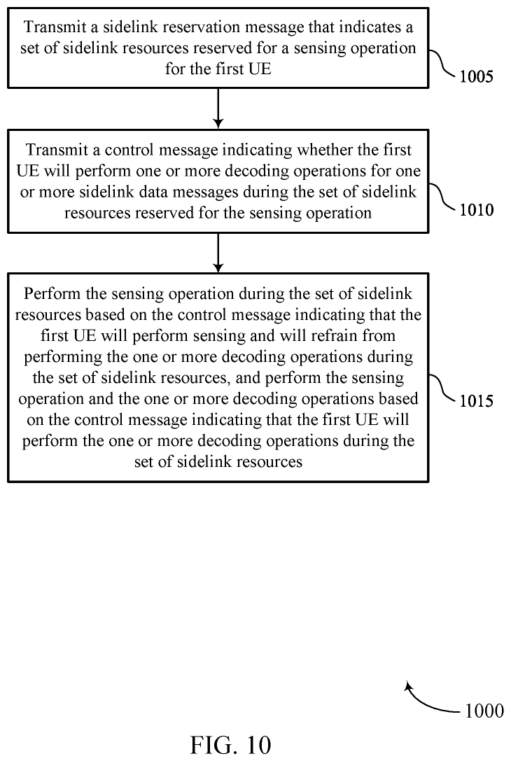

FIG. 10 shows a flowchart illustrating a method 1000 that supports techniques for sensing and communication beam conflict in sidelink in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1005, the method may include transmitting a sidelink reservation message that indicates a set of sidelink resources reserved for a sensing operation for the first UE. The operations of 1005 may be performed in accordance with examples as disclosed herein. In some examples, aspects of the operations of 1005 may be performed by a reservation messaging component 825 as described with reference to FIG. 8.

At 1010, the method may include transmitting a control message indicating whether the first UE will perform one or more decoding operations for one or more sidelink data messages during the set of sidelink resources reserved for the sensing operation. The operations of 1010 may be performed in accordance with examples as disclosed herein. In some examples, aspects of the operations of 1010 may be performed by a control messaging component 830 as described with reference to FIG. 8.

At 1015, the method may include performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources. The operations of 1015 may be performed in accordance with examples as disclosed herein. In some examples, aspects of the operations of 1015 may be performed by a sensing component 835 as described with reference to FIG. 8.

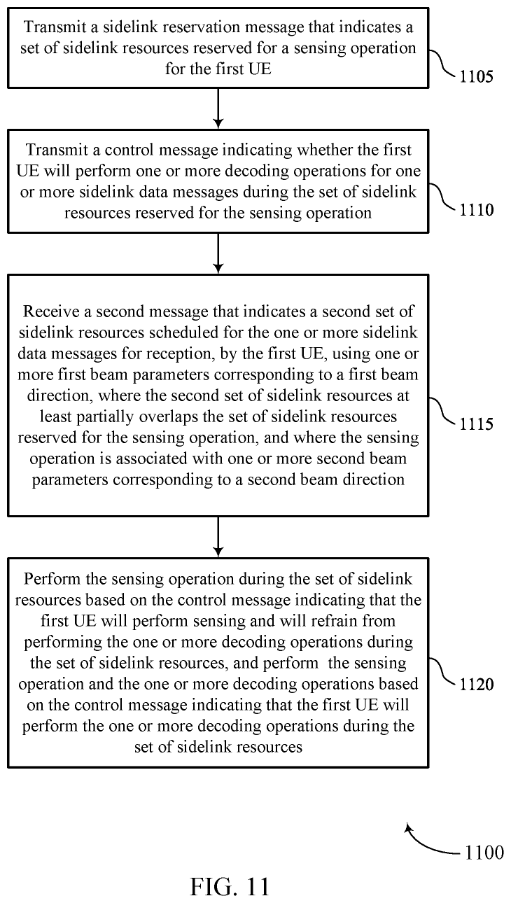

FIG. 11 shows a flowchart illustrating a method 1100 that supports techniques for sensing and communication beam conflict in sidelink in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1105, the method may include transmitting a sidelink reservation message that indicates a set of sidelink resources reserved for a sensing operation for the first UE. The operations of 1105 may be performed in accordance with examples as disclosed herein. In some examples, aspects of the operations of 1105 may be performed by a reservation messaging component 825 as described with reference to FIG. 8.

At 1110, the method may include transmitting a control message indicating whether the first UE will perform one or more decoding operations for one or more sidelink data messages during the set of sidelink resources reserved for the sensing operation. The operations of 1110 may be performed in accordance with examples as disclosed herein. In some examples, aspects of the operations of 1110 may be performed by a control messaging component 830 as described with reference to FIG. 8.

At 1115, the method may include receiving a second message that indicates a second set of sidelink resources scheduled for the one or more sidelink data messages for reception, by the first UE, using one or more first beam parameters corresponding to a first beam direction, where the second set of sidelink resources at least partially overlaps the set of sidelink resources reserved for the sensing operation, and where the sensing operation is associated with one or more second beam parameters corresponding to a second beam direction. The operations of 1115 may be performed in accordance with examples as disclosed herein. In some examples, aspects of the operations of 1115 may be performed by a sidelink reception component 845 as described with reference to FIG. 8.

At 1120, the method may include performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources. The operations of 1120 may be performed in accordance with examples as disclosed herein. In some examples, aspects of the operations of 1120 may be performed by a sensing component 835 as described with reference to FIG. 8.

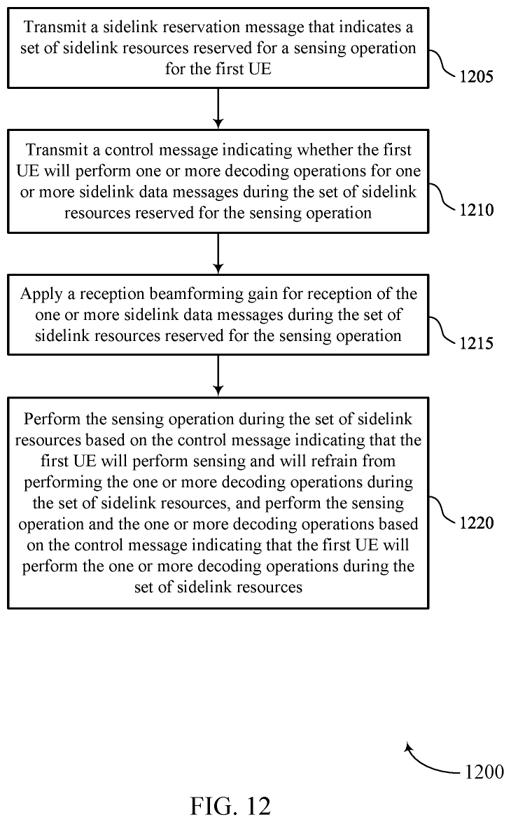

FIG. 12 shows a flowchart illustrating a method 1200 that supports techniques for sensing and communication beam conflict in sidelink in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1205, the method may include transmitting a sidelink reservation message that indicates a set of sidelink resources reserved for a sensing operation for the first UE. The operations of 1205 may be performed in accordance with examples as disclosed herein. In some examples, aspects of the operations of 1205 may be performed by a reservation messaging component 825 as described with reference to FIG. 8.

At 1210, the method may include transmitting a control message indicating whether the first UE will perform one or more decoding operations for one or more sidelink data messages during the set of sidelink resources reserved for the sensing operation. The operations of 1210 may be performed in accordance with examples as disclosed herein. In some examples, aspects of the operations of 1210 may be performed by a control messaging component 830 as described with reference to FIG. 8.

At 1215, the method may include applying a reception beamforming gain for reception of the one or more sidelink data messages during the set of sidelink resources reserved for the sensing operation. The operations of 1215 may be performed in accordance with examples as disclosed herein. In some examples, aspects of the operations of 1215 may be performed by a beamforming component 850 as described with reference to FIG. 8.

At 1220, the method may include performing the sensing operation during the set of sidelink resources based on the control message indicating that the first UE will perform sensing and will refrain from performing the one or more decoding operations during the set of sidelink resources, and performing the sensing operation and the one or more decoding operations based on the control message indicating that the first UE will perform the one or more decoding operations during the set of sidelink resources. The operations of 1220 may be performed in accordance with examples as disclosed herein. In some examples, aspects of the operations of 1220 may be performed by a sensing component 835 as described with reference to FIG. 8.

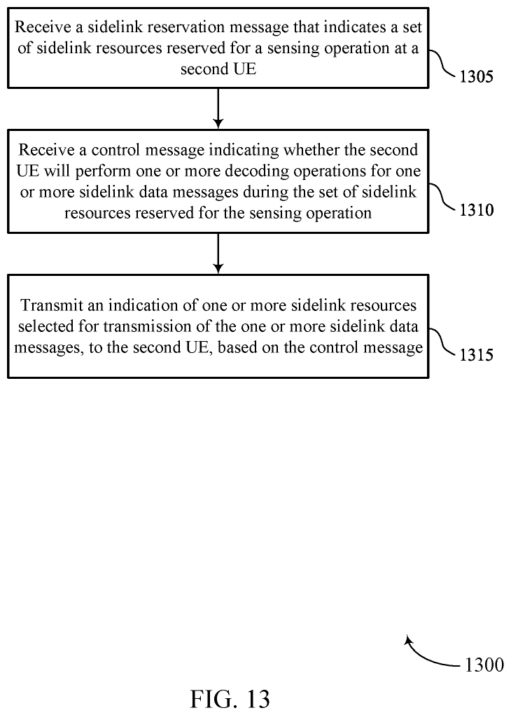

FIG. 13 shows a flowchart illustrating a method 1300 that supports techniques for sensing and communication beam conflict in sidelink in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving a sidelink reservation message that indicates a set of sidelink resources reserved for a sensing operation at a second UE. The operations of 1305 may be performed in accordance with examples as disclosed herein. In some examples, aspects of the operations of 1305 may be performed by a reservation messaging component 825 as described with reference to FIG. 8.

At 1310, the method may include receiving a control message indicating whether the second UE will perform one or more decoding operations for one or more sidelink data messages during the set of sidelink resources reserved for the sensing operation. The operations of 1310 may be performed in accordance with examples as disclosed herein. In some examples, aspects of the operations of 1310 may be performed by a control messaging component 830 as described with reference to FIG. 8.

At 1315, the method may include transmitting an indication of one or more sidelink resources selected for transmission of the one or more sidelink data messages, to the second UE, based on the control message. The operations of 1315 may be performed in accordance with examples as disclosed herein. In some examples, aspects of the operations of 1315 may be performed by a sidelink transmission component 840 as described with reference to FIG. 8.

### SUMMARY OF ASPECTS

The following provides an overview of aspects of the present disclosure:

Aspect 1: A method for wireless communications at a first UE, comprising: transmitting a sidelink reservation message that indicates a set of sidelink resources reserved for a sensing operation for the first UE; transmitting a control message indicating whether the first UE will perform one or more decoding operations for one or more sidelink data messages during the set of sidelink resources reserved for the sensing operation; and performing the sensing operation during the set of sidelink resources based at least in part on the control message indicating that the first UE will perform sensing and will refrain from performing the one or more decoding operations during the set of sidelink resources, and performing the sensing operation and the one or more decoding operations based at least in part on the control message indicating that the first UE will perform the one or more decoding operations during the set of sidelink resources.

Aspect 2: The method of aspect 1, further comprising: receiving a second message that indicates a second set of sidelink resources scheduled for the one or more sidelink data messages for reception, by the first UE, using one or more first beam parameters corresponding to a first beam direction, wherein the second set of sidelink resources at least partially overlaps the set of sidelink resources reserved for the sensing operation, and wherein the sensing operation is associated with one or more second beam parameters corresponding to a second beam direction.

Aspect 3: The method of aspect 2, wherein performing the sensing operation and the one or more decoding operations comprises: receiving the one or more sidelink data messages during the second set of sidelink resources based at least in part on receiving the second message; and decoding the one or more sidelink data messages during the second set of sidelink resources.

Aspect 4: The method of aspect 1, wherein transmitting the control message comprises: transmitting the control message indicating that the first UE will perform sensing and will refrain from performing the one or more decoding operations during the set of sidelink resources based at least in part on the one or more first beam parameters being different from the one or more second beam parameters.

Aspect 5: The method of any of aspects 1 through 4, wherein the set of sidelink resources reserved for the sensing operation comprises multiple consecutive slots.

Aspect 6: The method of any of aspects 1 through 3 and 5, wherein transmitting the control message comprises: transmitting an indication that the first UE will perform one or more decoding operations for one or more sidelink data messages for all slots of the multiple consecutive slots.

Aspect 7: The method of any of aspects 5 through 6, wherein transmitting the control message comprises: transmitting an indication of whether the first UE will perform the one or more decoding operations for the one or more sidelink data messages for each slot of the multiple consecutive slots.

Aspect 8: The method of any of aspects 1 through 3 and 5 through 7, wherein performing the sensing operation and the one or more decoding operations comprises: applying a reception beamforming gain for reception of the one or more sidelink data messages during the set of sidelink resources reserved for the sensing operation.

Aspect 9: The method of aspect 8, further comprising: transmitting an indication of the reception beamforming gain applied to the one or more sidelink data messages.

Aspect 10: The method of aspect 9, wherein transmitting the indication of the reception beamforming gain comprises: transmitting a gain offset that is indicative of the reception beamforming gain applied to the one or more sidelink data messages.

Aspect 11: The method of any of aspects 9 through 10, wherein transmitting the indication of the reception beamforming gain comprises: transmitting the indication of the reception beamforming gain via the sidelink reservation message or via a PC5-RRC connection.

Aspect 12: The method of any of aspects 9 through 11, wherein transmitting the indication of the reception beamforming gain comprises: transmitting an indication of one or more beam parameters corresponding to a beam direction that is associated with the one or more decoding operations.

Aspect 13: The method of aspect 12, wherein transmitting the indication of the one or more beam parameters comprises: transmitting an indication of an angle interval as part of the indication of the one or more beam parameters.

Aspect 14: The method of any of aspects 12 through 13, wherein transmitting the indication of the one or more beam parameters comprises: transmitting an indication of a set of one or more transmission configuration indication states as part of the one or more beam parameters.

Aspect 15: The method of any of aspects 1 through 14, wherein transmitting the control message comprises: transmitting the control message via a sidelink control information message or via a medium access control (MAC) control element (MAC-CE).

Aspect 16: A method for wireless communications at a first UE, comprising: receiving a sidelink reservation message that indicates a set of sidelink resources reserved for a sensing operation at a second UE; receiving a control message indicating whether the second UE will perform one or more decoding operations for one or more sidelink data messages during the set of sidelink resources reserved for the sensing operation; and transmitting an indication of one or more sidelink resources selected for transmission of the one or more sidelink data messages, to the second UE, based at least in part on the control message.

Aspect 17: The method of aspect 16, wherein transmitting the indication of the one or more sidelink resources selected for the transmission of the one or more sidelink data messages comprises: transmitting, to the second UE, the indication of the one or more sidelink resources selected for the transmission of the one or more sidelink data messages, wherein the one or more sidelink resources are selected based at least in part on exclusion of one or more sidelink resources of the set of sidelink resources reserved for the sensing operation at the second UE, wherein the one or more sidelink resources are excluded from the set of sidelink resources based at least in part on the control message indicating that the first UE will perform sensing and will refrain from performing the one or more decoding operations during the set of sidelink resources.

Aspect 18: The method of any of aspects 16 through 17, further comprising: receiving, from the second UE, an indication of a reception beamforming gain for the one or more sidelink data messages, an indication of one or more beam parameters corresponding to a beam direction, the beam direction associated with the one or more decoding operations, or a combination thereof.

Aspect 19: The method of aspect 18, wherein receiving the indication of the one or more beam parameters comprises: receiving an indication of an angle interval as part of the indication of the one or more beam parameters.

Aspect 20: The method of any of aspects 18 through 19, wherein transmitting the indication of the one or more sidelink resources selected for the transmission of the one or more sidelink data messages comprises: transmitting, to the second UE, the indication of the one or more sidelink resources selected for the transmission of the one or more sidelink data messages, wherein the one or more sidelink resources are selected based at least in part on exclusion of one or more sidelink resources of the set of sidelink resources reserved for the sensing operation at the second UE, wherein the one or more sidelink resources are excluded from the set of sidelink resources based at least in part on the indication of the reception beamforming gain, the indication of the one or more beam parameters, or a combination thereof.

Aspect 21: The method of aspect 20, wherein the one or more sidelink resources are excluded from the set of sidelink resources based at least in part on the reception beamforming gain exceeding a threshold.

Aspect 22: The method of any of aspects 16 through 21, further comprising: excluding one or more sidelink resources from a window used for selecting the one or more sidelink resources selected for the transmission of the one or more sidelink data messages; and including the one or more sidelink resources in the one or more sidelink resources selected for the transmission of the one or more sidelink data messages based at least in part on a quantity of resources within the window being below a threshold.

Aspect 23: The method of aspect 22, wherein selecting the one or more excluded resources comprises: selecting the one or more excluded resources based at least in part on a reference signal received power associated with each of the one or more excluded resources, a priority value associated with each of the one or more excluded resources, or a combination thereof.

Aspect 24: The method of aspect 23, wherein the reference signal received power and the priority value are based at least in part on one or more beamforming capabilities indicated by the sidelink reservation message, the one or more excluded resources are associated with one or more sidelink resources of the set of sidelink resources reserved for the sensing operation at the second UE.

Aspect 25: The method of any of aspects 16 and 18 through 24, further comprising: transmitting the one or more sidelink data messages during the set of sidelink resources reserved for the sensing operation based at least in part on the control message indicating that the second UE will perform the one or more decoding operations during the set of sidelink resources.

Aspect 26: The method of any of aspects 16 through 24, further comprising: refraining from transmitting the one or more sidelink data messages during the set of sidelink resources reserved for the sensing operation based at least in part on the control message indicating that the second UE will perform sensing and will refrain from performing the one or more decoding operations during the set of sidelink resources.

Aspect 27: An apparatus for wireless communications at a first UE, comprising a processor; memory coupled with the processor; and instructions stored in the memory and executable by the processor to cause the apparatus to perform a method of any of aspects 1 through 15.

Aspect 28: An apparatus for wireless communications at a first UE, comprising at least one means for performing a method of any of aspects 1 through 15.

Aspect 29: A non-transitory computer-readable medium storing code for wireless communications at a first UE, the code comprising instructions executable by a processor to perform a method of any of aspects 1 through 15.

Aspect 30: An apparatus for wireless communications at a first UE, comprising a processor; memory coupled with the processor; and instructions stored in the memory and executable by the processor to cause the apparatus to perform a method of any of aspects 16 through 26.

Aspect 31: An apparatus for wireless communications at a first UE, comprising at least one means for performing a method of any of aspects 16 through 26.

Aspect 32: A non-transitory computer-readable medium storing code for wireless communications at a first UE, the code comprising instructions executable by a processor to perform a method of any of aspects 16 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first UE, comprising:
a processor;
memory coupled with the processor; and
one or more instructions stored in the memory and executable by the processor to cause the apparatus to, based at least in part on the one or more instructions:
transmit a sidelink reservation message that indicates a set of sidelink resources reserved for a sensing operation for the first UE;
transmit a control message indicating whether the first UE will perform one or more decoding operations for one or more sidelink data messages during the set of sidelink resources reserved for the sensing operation; and
perform the sensing operation during the set of sidelink resources based at least in part on the control message indicating that the first UE will perform sensing and will refrain from performing the one or more decoding operations during the set of sidelink resources, and perform the sensing operation and the one or more decoding operations based at least in part on the control message indicating that the first UE will perform the one or more decoding operations during the set of sidelink resources.

2. The apparatus of claim 1, wherein the instructions are further executable by the processor to cause the apparatus to:
receive a second message that indicates a second set of sidelink resources scheduled for the one or more sidelink data messages for reception, by the first UE, using one or more first beam parameters corresponding to a first beam direction, wherein the second set of sidelink resources at least partially overlaps the set of sidelink resources reserved for the sensing operation, and wherein the sensing operation is associated with one or more second beam parameters corresponding to a second beam direction.

3. The apparatus of claim 2, wherein the instructions to perform the sensing operation and the one or more decoding operations are executable by the processor to cause the apparatus to:
receive the one or more sidelink data messages during the second set of sidelink resources based at least in part on receiving the second message; and decode the one or more sidelink data messages during the second set of sidelink resources.

4. The apparatus of claim 2, wherein the instructions to transmit the control message are executable by the processor to cause the apparatus to:
transmit the control message indicating that the first UE will perform sensing and will refrain from performing the one or more decoding operations during the set of sidelink resources based at least in part on the one or more first beam parameters being different from the one or more second beam parameters.

5. The apparatus of claim 1, wherein the set of sidelink resources reserved for the sensing operation comprises multiple consecutive slots.

6. The apparatus of claim 5, wherein the instructions to transmit the control message are executable by the processor to cause the apparatus to:
transmit an indication that the first UE will perform one or more decoding operations for one or more sidelink data messages for all slots of the multiple consecutive slots.

7. The apparatus of claim 5, wherein the instructions to transmit the control message are executable by the processor to cause the apparatus to:
transmit an indication of whether the first UE will perform the one or more decoding operations for the one or more sidelink data messages for each slot of the multiple consecutive slots.

8. The apparatus of claim 1, wherein the instructions to perform the sensing operation and the one or more decoding operations are executable by the processor to cause the apparatus to:
apply a reception beamforming gain for reception of the one or more sidelink data messages during the set of sidelink resources reserved for the sensing operation.

9. The apparatus of claim 8, wherein the instructions are further executable by the processor to cause the apparatus to:
transmit an indication of the reception beamforming gain applied to the one or more sidelink data messages.

10. The apparatus of claim 9, wherein the instructions to transmit the indication of the reception beamforming gain are executable by the processor to cause the apparatus to:
transmit a gain offset that is indicative of the reception beamforming gain applied to the one or more sidelink data messages.

11. The apparatus of claim 9, wherein the instructions to transmit the indication of the reception beamforming gain are executable by the processor to cause the apparatus to:
transmit the indication of the reception beamforming gain via the sidelink reservation message or via a PC5-RRC connection.

12. The apparatus of claim 9, wherein the instructions to transmit the indication of the reception beamforming gain are executable by the processor to cause the apparatus to:
transmit an indication of one or more beam parameters corresponding to a beam direction that is associated with the one or more decoding operations.

13. The apparatus of claim 12, wherein the instructions to transmit the indication of the one or more beam parameters are executable by the processor to cause the apparatus to:
transmit an indication of an angle interval as part of the indication of the one or more beam parameters.

14. The apparatus of claim 12, wherein the instructions to transmit the indication of the one or more beam parameters are executable by the processor to cause the apparatus to:
transmit an indication of a set of one or more transmission configuration indication states as part of the one or more beam parameters.

15. The apparatus of claim 1, wherein the instructions to transmit the control message are executable by the processor to cause the apparatus to:
transmit the control message via a sidelink control information message or via a medium access control (MAC) control element (MAC-CE).

16. An apparatus for wireless communications at a first UE, comprising:
a processor;
memory coupled with the processor; and
one or more instructions stored in the memory and executable by the processor to cause the apparatus to, based at least in part on the one or more instructions:
receive a sidelink reservation message that indicates a set of sidelink resources reserved for a sensing operation at a second UE;
receive a control message indicating whether the second UE will perform one or more decoding operations for one or more sidelink data messages during the set of sidelink resources reserved for the sensing operation; and
transmit an indication of one or more sidelink resources selected for transmission of the one or more sidelink data messages, to the second UE, based at least in part on the control message.

17. The apparatus of claim 16, wherein the instructions to transmit the indication of the one or more sidelink resources selected for the transmission of the one or more sidelink data messages are executable by the processor to cause the apparatus to:
transmit, to the second UE, the indication of the one or more sidelink resources selected for the transmission of the one or more sidelink data messages,
wherein the one or more sidelink resources are selected based at least in part on exclusion of one or more sidelink resources of the set of sidelink resources reserved for the sensing operation at the second UE, wherein the one or more sidelink resources are excluded from the set of sidelink resources based at least in part on the control message indicating that the first UE will perform sensing and will refrain from performing the one or more decoding operations during the set of sidelink resources.

18. The apparatus of claim 16, wherein the instructions are further executable by the processor to cause the apparatus to:
receive, from the second UE, an indication of a reception beamforming gain for the one or more sidelink data messages, an indication of one or more beam parameters corresponding to a beam direction, the beam direction associated with the one or more decoding operations, or a combination thereof.

19. The apparatus of claim 18, wherein the instructions to receive the indication of the one or more beam parameters are executable by the processor to cause the apparatus to:
receive an indication of an angle interval as part of the indication of the one or more beam parameters.

20. The apparatus of claim 18, wherein the instructions to transmit the indication of the one or more sidelink resources selected for the transmission of the one or more sidelink data messages are executable by the processor to cause the apparatus to:
transmit, to the second UE, the indication of the one or more sidelink resources selected for the transmission of the one or more sidelink data messages, wherein the one or more sidelink resources are selected based at least in part on exclusion of one or more sidelink resources of the set of sidelink resources reserved for the sensing operation at the second UE, wherein the one or more sidelink resources are excluded from the set of sidelink resources based at least in part on the indication of the reception beamforming gain, the indication of the one or more beam parameters, or a combination thereof.

21-30. (canceled)
